(19) United States
(12) Patent Application Publication
(10) Pub. No.: US 2024/0281750 A1
(43) Pub. Date: Aug. 22, 2024

(54) Scanner-Based Determination of Cargo Weight

(71) Applicant: Trego/Dugan Aviation of Grand Island, Inc., North Platte, NE (US)

(72) Inventors: Traci Trego Dugan, North Platte, NE (US); Brent Davis Kostella, Monaca, PA (US); Robert Neal Keller, Spokane, WA (US)

(21) Appl. No.: 18/581,257

(22) Filed: Feb. 19, 2024

Related U.S. Application Data
(60) Provisional application No. 63/446,971, filed on Feb. 20, 2023.

(51) Int. Cl. G06Q 10/0833; G06K 7/14

(52) U.S. Cl. CPC G06Q 10/0833; G06K 7/1417

(57) ABSTRACT

A computer-implemented method is provided. The computer-implemented method includes obtaining, by way of a scanning device coupled to a computing system, an identifier of a container, where the container is associated with a transportation number. The computer-implemented method also includes obtaining, by way of the scanning device, a weight based on that of the container as determined by a scale. The computer-implemented method additionally includes printing, by a printing device coupled to the computing system, a placard encoding the identifier, the transportation number, and the weight. The computer-implemented method further includes storing, in a database associated with the computing system, an entry associating the identifier, the transportation number, and the weight.

### CROSS-REFERENCE TO RELATED APPLICATION

This application claims priority to U.S. Provisional Patent Application No. 63/446,971, filed Feb. 20, 2023, the entire contents of which are hereby incorporated by reference.

### BACKGROUND

Accurate scale data entry and weight calculations are essential in safe weight and balance recording, computing, planning and loading of cargo aircraft. Typically, data is entered at the scale and then numerically calculated and recorded on a log sheet and loading device placard. This process is too slow for modern requirements of rapid delivery of goods and just-in-time supply chain management, not to mention that even very small errors cause catastrophic results. Further, changes to cargo data occur frequently as cargo is reweighed and/or placed on another cargo aircraft for transport. The log sheets and loading device placard are often not updated to reflect these changes, resulting in inaccurate balancing data. In the cargo aircraft industry, data discrepancies are not tolerated. Such data discrepancies can lead to an aircraft in an out of balance scenario where flight characteristics do not align with proper flight control inputs. Placing an aircraft in an out of balance state creates a high risk of accidents arising after takeoff. Aircraft accidents place air crews, equipment, and the general public in danger when the discrepancies interfere with flight characteristics of the cargo aircraft. Thus, properly balancing loads on an aircraft by providing accurate data increases the safety of flight.

### SUMMARY

In a first example embodiment, a computer-implemented method is provided. The computer-implemented method may include obtaining, by way of a scanning device coupled to a computing system, an identifier of a container, where the container is associated with a transportation number. The computer-implemented method may also include obtaining, by way of the scanning device, a weight based on that of the container as determined by a scale. The computer-implemented method may also include printing, by a printing device coupled to the computing system, a placard encoding the identifier, the transportation number, and the weight. The computer-implemented method may also include storing, in a database associated with the computing system, an entry associating the identifier, the transportation number, and the weight.

In a second example embodiment, a computing system may include at least one processor, as well as memory and program instructions. The program instructions may be stored in the memory, and upon execution by the at least one processor, cause the computing system to perform operations in accordance with the first example embodiment.

In a third example embodiment, an article of manufacture may include a non-transitory computer-readable medium, having stored thereon program instructions that, upon execution by a computing system, cause the computing system to perform operations in accordance with the first example embodiment.

In a fourth example embodiment, a system may include various means for carrying out each of the operations of the first example embodiment.

These as well as other aspects, advantages, and alternatives will become apparent to those of ordinary skill in the art by reading the following detailed description, with reference, where appropriate, to the accompanying drawings.

### BRIEF DESCRIPTION OF THE DRAWINGS

The accompanying drawings, which are incorporated in and constitute a part of this specification, illustrate multiple embodiments of the presently disclosed subject matter and, together with the description, serve to explain the principles of the presently disclosed subject matter; and, furthermore, are not intended in any manner to limit the scope of the presently disclosed subject matter.

FIG. 1 illustrates a simplified block diagram exemplifying a computing device, illustrating some of the components that could be included in a computing device arranged to operate according to exemplary embodiments of the present disclosure.

FIG. 2 illustrates a cloud-based server cluster according to exemplary embodiments of the present disclosure.

FIG. 3 illustrates an installation flow diagram according to exemplary embodiments of the present disclosure.

FIG. 4A illustrates an application launch flow diagram according to exemplary embodiments of the present disclosure.

FIG. 4B illustrates an application start-up flow diagram according to exemplary embodiments of the present disclosure.

FIG. 5A illustrates an on screen display of a flight data entry according to exemplary embodiments of the present disclosure.

FIG. 5B illustrates a flight data entry flow diagram that may be used with the flight data entry of FIG. 5A according to exemplary embodiments of the present disclosure.

FIGS. 5C and 5D illustrate pop-up messages, according to exemplary embodiments of the present disclosure.

FIG. 6A illustrates an on screen display of a weighing module data entry according to exemplary embodiments of the present disclosure.

FIG. 6B illustrates a weighing module data entry flow diagram that may be used with the weighing module data entry of FIG. 6A according to exemplary embodiments of the present disclosure.

FIG. 6C illustrates a flow diagram that may be used to generate the placard of FIG. 6B according to exemplary embodiments of the present disclosure.

FIG. 6D illustrates the placard of FIG. 6B according to exemplary embodiments of the present disclosure.

FIG. 6E illustrates a flow diagram for verifying scale data that may be used with block of FIG. 6B according to exemplary embodiments of the present disclosure.

FIG. 7A illustrates an on screen display of a unit load device (ULD) type/name verification according to exemplary embodiments of the present disclosure.

FIG. 7B illustrates a ULD type/name verification flow diagram that may be used with the ULD type/name verification of FIG. 7A according to exemplary embodiments of the present disclosure.

FIG. 8A illustrates an on screen display of a ULD completion verification according to exemplary embodiments of the present disclosure.

FIG. 8B illustrates a ULD completion verification flow diagram that may be used with the ULD completion verification of FIG. 8A according to exemplary embodiments of the present disclosure.

FIG. 8C illustrates an on screen display of a ULD indicator, according to exemplary embodiments of the present disclosure.

FIG. 9A illustrates an on screen display of log interactions according to exemplary embodiments of the present disclosure.

FIG. 9B illustrates a log interactions flow diagram that may be used with the log interactions of FIG. 9A according to exemplary embodiments of the present disclosure.

FIG. 10A illustrates an on screen display of a log file according to exemplary embodiments of the present disclosure.

FIG. 10B illustrates a log file flow diagram that may be used with the log file of FIG. 10A according to exemplary embodiments of the present disclosure.

FIG. 10C illustrates a log printout generation flow diagram that may be used with clock of FIG. 10B according to exemplary embodiments of the present disclosure.

FIG. 11 illustrates a log data validation flow diagram according to exemplary embodiments of the present disclosure.

FIG. 12 illustrates a view menus flow diagram according to exemplary embodiments of the present disclosure.

FIG. 13 illustrates a print menu module flow diagram according to exemplary embodiments of the present disclosure.

FIG. 14 illustrates a view menus flow diagram according to exemplary embodiments of the present disclosure.

FIG. 15 illustrates an edit menus flow diagram according to exemplary embodiments of the present disclosure.

FIG. 16 illustrates a database schema according to exemplary embodiments of the present disclosure.

FIG. 17 illustrates a flight data lookup flow diagram according to exemplary embodiments of the present disclosure.

FIG. 18 illustrates a log display flow diagram according to exemplary embodiments of the present disclosure.

FIG. 19 illustrates a ULD removal flow diagram according to exemplary embodiments of the present disclosure.

FIG. 20 illustrates an empty ULD flow diagram according to exemplary embodiments of the present disclosure.

FIG. 21 illustrates a flight change flow diagram according to exemplary embodiments of the present disclosure.

FIG. 22 illustrates a load planner modifications flow diagram according to exemplary embodiments of the present disclosure.

FIG. 23 illustrates a scale operator modifications flow diagram according to exemplary embodiments of the present disclosure.

FIG. 24 illustrates a plane side agent (PSA) modification verifier flow diagram according to exemplary embodiments of the present disclosure.

FIG. 25 illustrates a quick response (QR) code generation flow diagram according to exemplary embodiments of the present disclosure.

FIG. 26 illustrates a flight addition, removal, and verification flow diagram according to exemplary embodiments of the present disclosure.

FIG. 27 illustrates an automated load verification (ALV) menu flow diagram according to exemplary embodiments of the present disclosure.

FIG. 28 illustrates a help menu flow diagram according to exemplary embodiments of the present disclosure.

FIG. 29 illustrates an on-screen display of a full screen interface according to exemplary embodiments of the present disclosure.

FIG. 30 illustrates a flow chart of an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

The digital scale app (“the application”) facilitates the weighing of and identifying cargo that will be loaded to the aircraft. To accomplish this the application leverages barcode and QR code scanning technology to ensure consistent and accurate measurements and information. Through careful calibration of information such as dolly and container weights as well as strict naming conventions, scanner codes can be configured for reuse on these items. By utilizing the scanner codes in place and use of the application, data, such as the dolly and container weights, can be consistently and accurately input and referenced through the ability to scan the information. Additionally, configuration of QR codes to scan in other information like contents or other commonly used remarks eliminates other areas that can lead to inaccurate information. Furthermore, the application may provide a real-time or near real-time determination of accurate loading weights for use on specific aircraft configurations. Carefully following industry standards and regulations for calibration and measurement of equipment tare weights at required intervals can allow this information to be formatted into scannable codes that can be reused as necessary. Thus, the application can utilize the scannable codes to greatly reduce the risk by ensuring accurate scale data is used to determine the safest possible planning and loading of cargo aircraft. This results in an accurate balancing determination for the specific aircraft configuration, which can reduce the occurrence of catastrophic failure and increase overall flight safety of crew and equipment. Furthermore, these benefits can be accomplished while meeting rigid timing requirements.

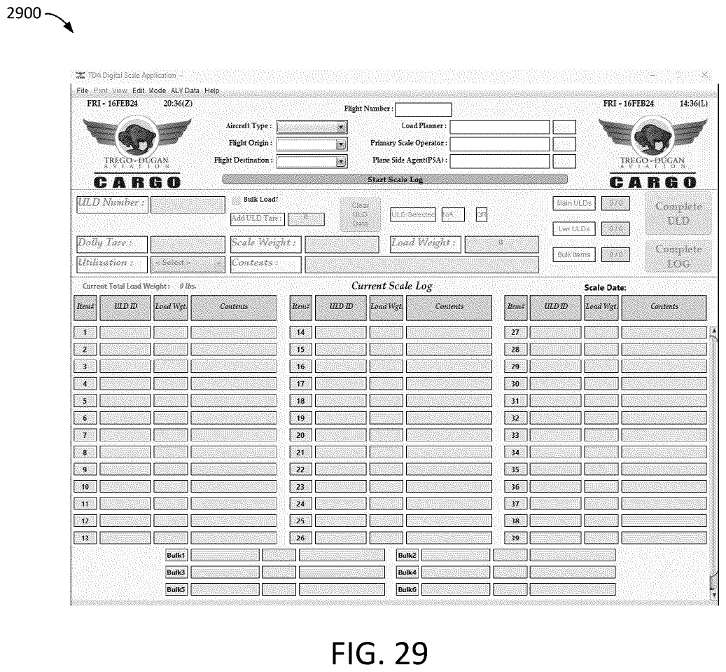

The application has detailed and intuitive flows in the main interface (see FIG. 29). Details of the flows are outlined in one or more of the figures described in this document. User friendly organized menus assist users in performing common tasks not driven by the main interface.

Output data files may be customized to meet specific customer needs. In some examples, load data is annotated on ULD placards and scale logs for the intended transport aircraft.

The application can use Java Runtime Environment (JRE) on various computing platforms. Additionally, the application can use a printer and barcode/QR code scanner. Recommended (but not required) periphery hardware is the HP 200 mobile series Inkjet printer and the MDJ-9000A scanner. Other software and/or hardware can also be used.

In some examples, during installation customers can populate the self-contained structured query language (SQL) database with destinations, origins and flight numbers that can be used at the installation site. These entries can be modified from within the application allowing scalability for each installation.

In one example, the installation comes with 4 pre-programmed airframe types: 737-800, 767-200, 767-300 and the ATR72. However, in other examples the installation may come with greater than or less than 4 pre-programmed airframe types. These pre-programmed airframe types work with the purpose-built airframe models as well as passenger to freighter (P2F) conversions completed by the 3 major conversion companies: BCF—Boeing Converted Freighter, BDSF—Bedek Special Freighter, and PCF—Precision Conversions Freighter.

Like other aspects of the software, additional airframes can be added into each unique installation adding the scalability to match customers changing needs. Thus, the above information is meant as a non-limiting example of airframe types that can be added. Further information concerning the interface to implement these customizations will be detailed later in this document.

In some examples, the application uses a Graphical User Interface (GUI) to guide users through the weighing and identification process to complete a scale log used to enter information into a load planning software. The GUI can be located on a user device, such as a handheld user device, for example. The flow of the process and operations for each area of the interface are detailed below.

At the heart of every cargo flight is knowing information such as where the cargo is coming from, where the cargo is going to, what type of vehicle the cargo is moving in, and an identifier for the scheduled route (e.g., a flight number). Additionally, it can be desirable to know the individual(s) responsible for verifying that the data entered is accurate. The flight data section of the interface can provide entry of such data. Keeping an up-to-date record of this data, that can be accessible by multiple users across multiple user devices, can provide more consistent tracking and greater visibility throughout the process.

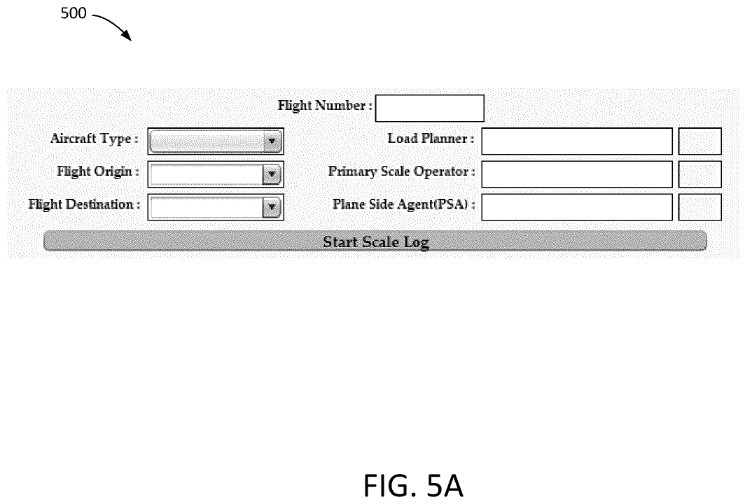

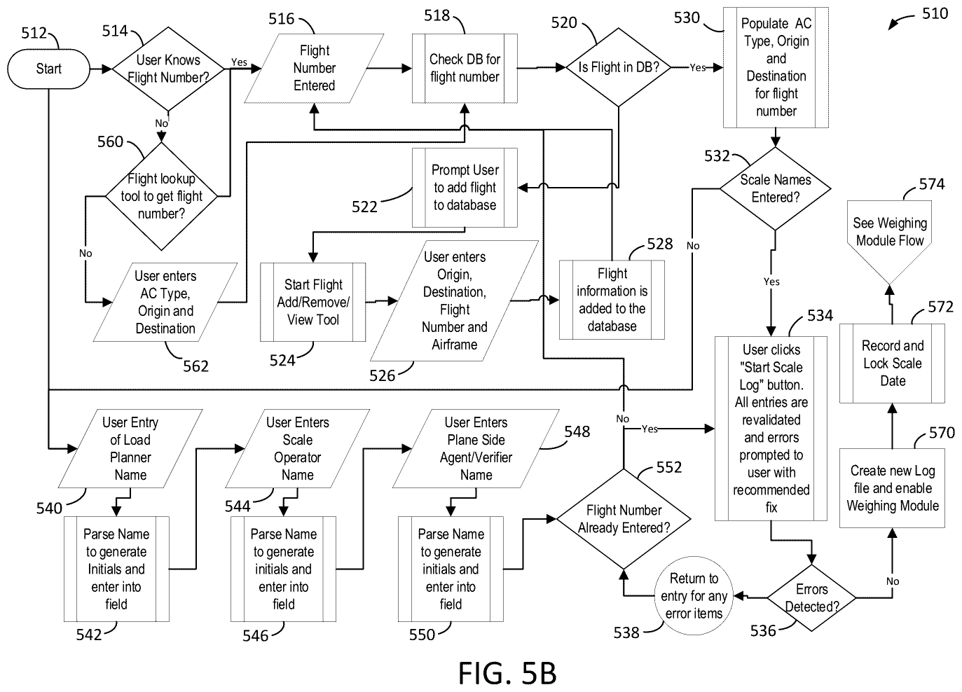

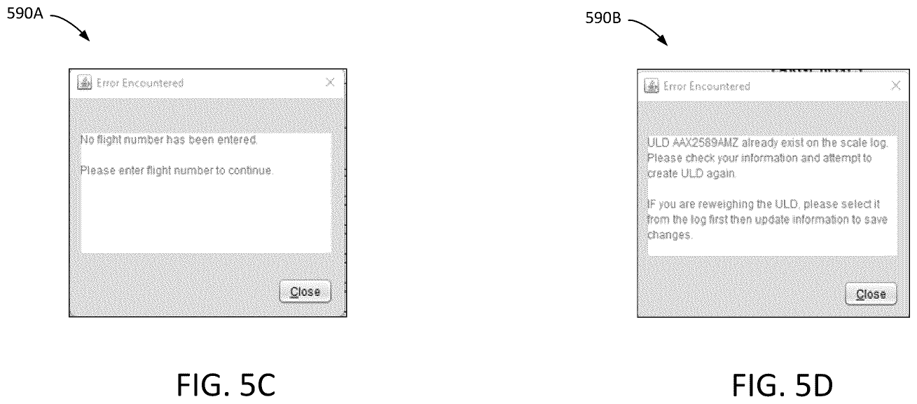

Flights and routes typically utilize the same flight numbers on a daily basis. The application can allow selection of either a flight number to pre-populate the aircraft type, origin and destination or entry of the aircraft type along with the origin and destination to automatically populate the flight number. All of these entries can be selected from drop down menus allowing the user to quickly and accurately choose items based on the current activity. The data associated with the drop-down menu selection and/or entered flight number can be stored in a database and received by the application for display on the GUI. Because this data can be valuable in properly documenting all load devices for the flight, in some examples this section is located at the top of the interface. The user(s) performing the weighing can input their name in the appropriate areas which then identifies accountable parties for proper documentation. There is flexibility in the way to populate these fields. For instance, in another example population of these fields can be accomplished from an employee database which allows drop down selections as well (not illustrated). Once all required information has been entered the user(s) can select the ‘Start Scale Log’ Button (see FIG. 5A) to enable the entry of items to be weighed for the specified flight. Once the ‘Start Scale Log’ button is selected, subsequent changes to this section can be locked out to ensure accuracy and data integrity.

As mentioned, in some examples four basic pieces of information can be required for any cargo flight. These pieces of data can be pre-loaded into a database at the time of installation. The database can be within the application or accessed remotely (e.g., via a wireless network) by the application. Also, as indicated the data can be added at any time to the database to make the selections available through the drop-down menus to facilitate the look up process. Thus, the database can be updated to accommodate changes to existing selections and/or make new selections available. To make the additions the user can select an ‘Add Flight’ option from an ‘Edit’ menu and can be prompted to enter the required information, for example. To ensure accuracy, a double entry of all information can be required. Additionally, this option can be password protected to allow the feature to be utilized by properly authorized individuals as desired.

Further, in some examples, the ‘Edit’ menu can allow entry of additional airframes. This process is much more involved as it can require additional information such as the maximum number of load units, load unit types, load configurations, etc. to be entered and would be for advanced users to implement additional airframe choices. Due to the complexity and variable nature of this process it is not illustrated in this document.

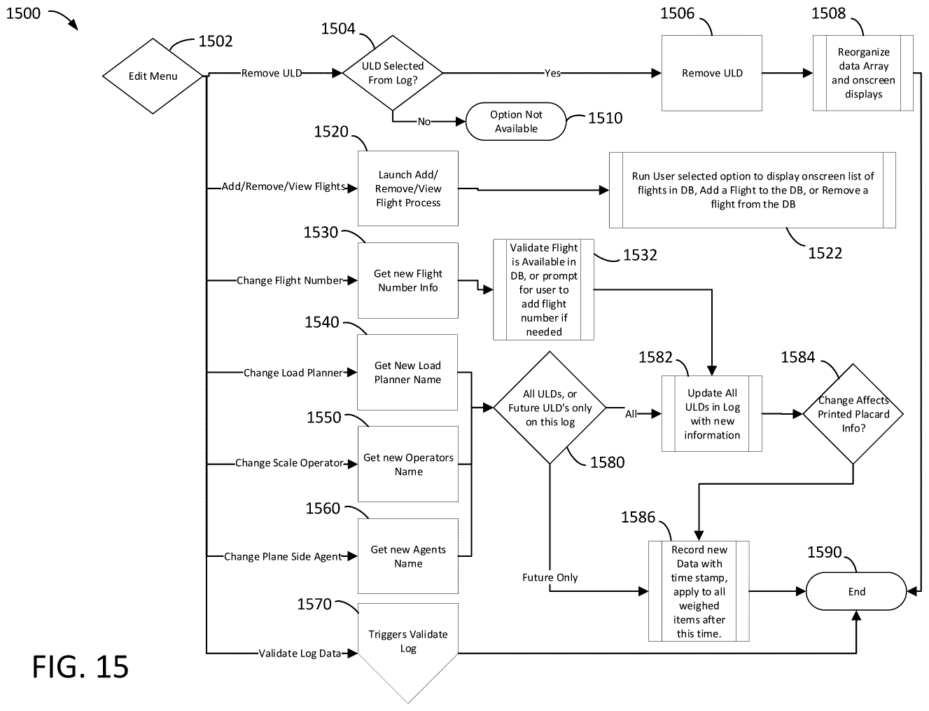

Once enabled the edit menu can also display options for adding operators to the list to select from the drop-down menus (see FIG. 15). As can be required for other entries, this can be set to require a double entry to validate accuracy for use.

Lastly, included in this section of the interface is a display of the current date and times. The current date may be displayed in a standard format. Time may be displayed both in local as well as Zulu time (UTC) which is the time flight schedules are filed. Adherence to flight times/departures can be important, so this feature keeps the information visible to the user (front and center) to promote timely and efficient weighing activities and capturing on-time departures.

Accurate scale information and calculation is essential in safe planning and loading of cargo aircraft. As previously stated, properly balancing loads on an aircraft is dependent at least partially on accurate cargo weights. Unbalanced aircraft through improper loading can pose a great safety risk to crew and equipment, as the aircraft can become unstable after take-off. Thus, ensuring accurate scale information and calculation can result in a properly balanced aircraft and increase overall flight safety. This section of the interface is the center of making sure that this happens.

The flow of information in this section follows the information that may be desired for any load devices to be included on the aircraft. Scale operators and load planners need to know how to identify each load device as well as information on how much it weighs, how much any intermediary transport equipment (dollies) weigh and to be able to accurately determine the actual weight to be placed in the aircraft. Additionally, how full the load device is (Utilization) and what is in that load devices may be desirable factors as well. Each of these items can be configured using reusable barcodes or QR codes. The scale operator can use a handheld scanner to scan loads in succession to enter accurate information each time the operation is performed. In one example the handheld scanner includes an optical sensor that can capture barcode and/or QR code information. ULDs (e.g., containers, cans, racks, pallets, and/or other devices designed for loading cargo onto and offloading cargo from an aircraft) throughout the cargo industry have unique identities that are often encoded into labels by the manufacture and thus can be leveraged by the application via the handheld scanner. As for dollies or other intermediary transport devices, industry standard requires these to routinely be weighed in an empty state as part of safety and maintenance procedures. Any time this is performed a new barcode or QR code should be generated using third-party software to appropriately record the weight for the duration of the period of use. Scanning these codes enters (inserts) the desired information into the appropriate boxes. For example, the scanner may use the codes to retrieve data about the object then display the retrieved data within the GUI of the application.

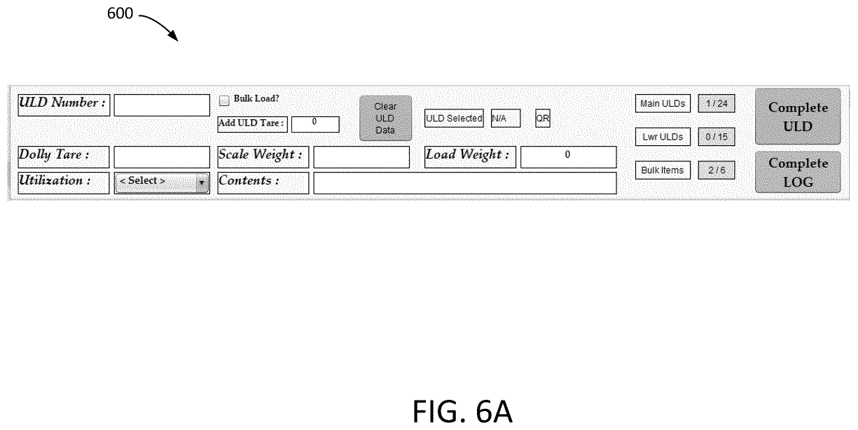

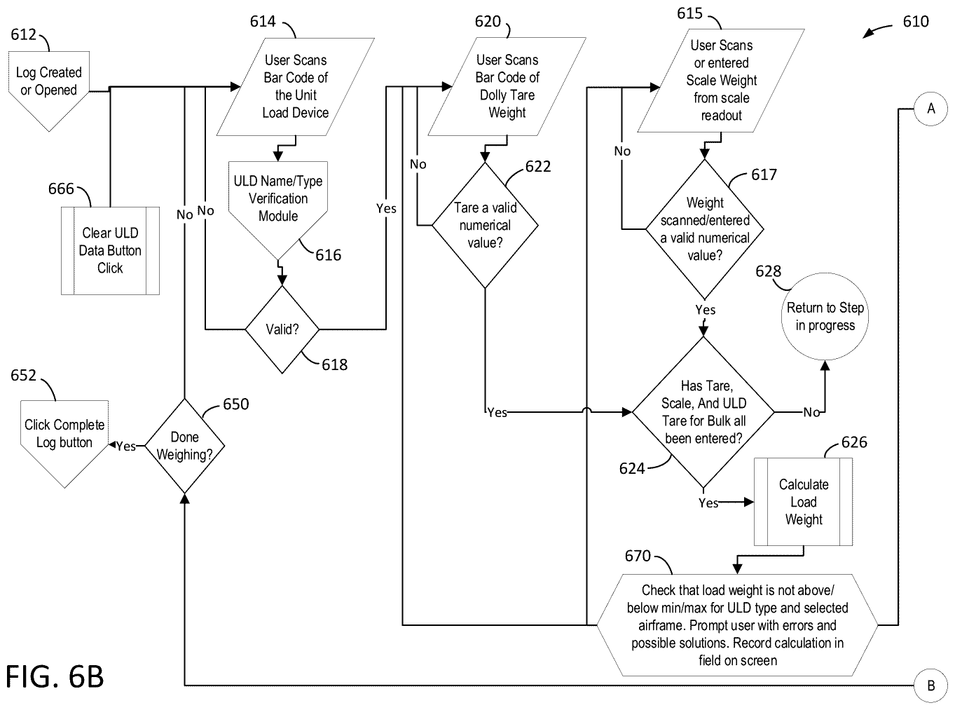

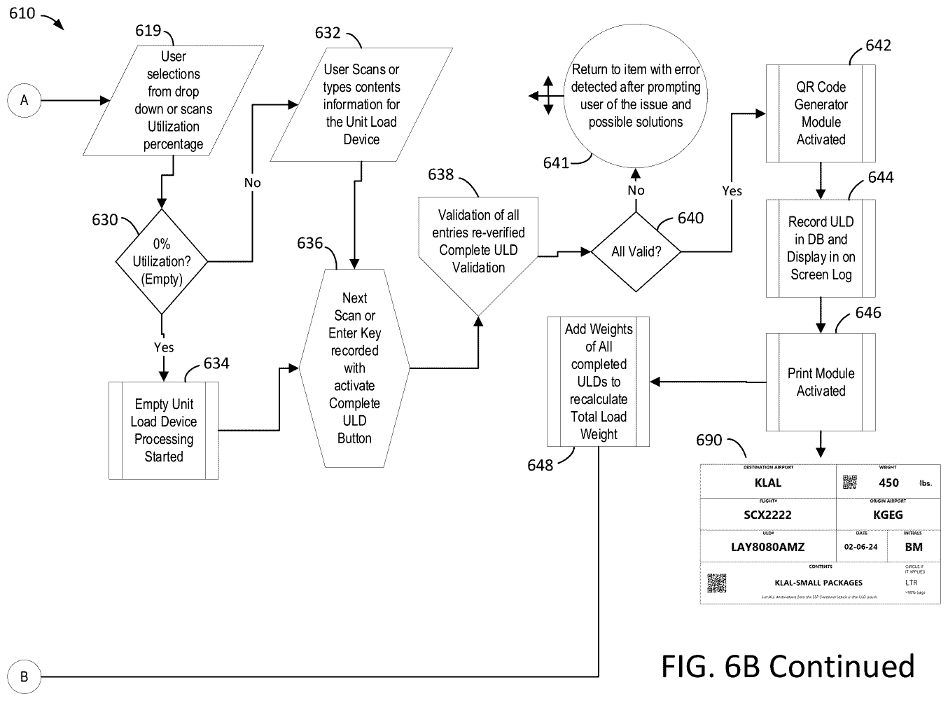

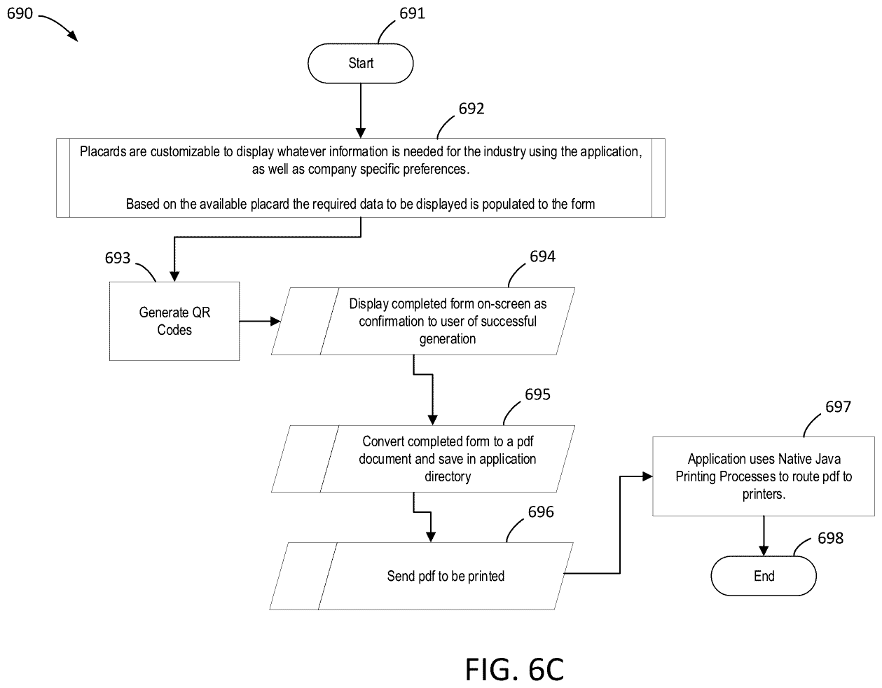

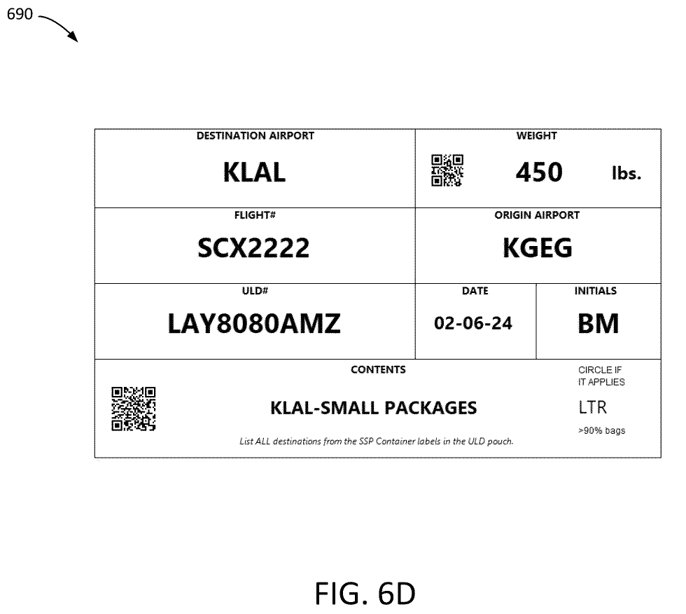

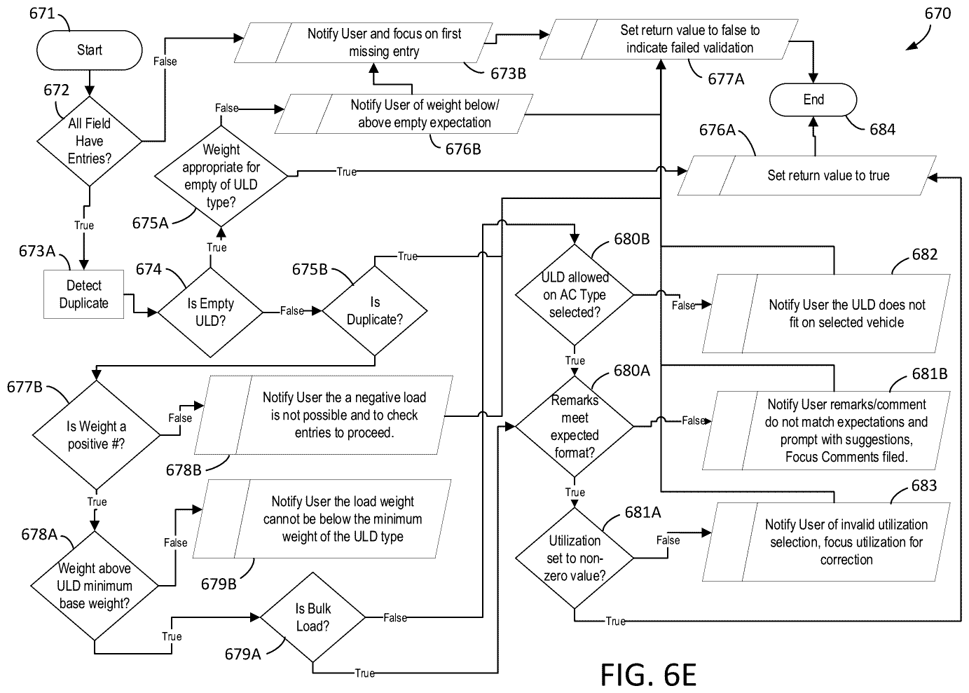

Scale weight is generated by the physical scale at the site and dependent on the customer hardware (scale type). Some scales can display QR codes natively that can be scanned and leveraged by the application to enter information. Other examples can have output configured through third-party devices to generate a QR code, or even configured to feed information directly to the computer being utilized by the application so that the weight is automatically recorded in the ‘Scale Weight’ field (see FIG. 6A). As this method can vary from customer to customer the default option leaves this as a field that can be filled either by scanning or inputting information from the scale display into this section. Other options are available through a customized installation as determined by the customer needs and/or available scale hardware.

Occasionally the ULD also serves as an intermediary for transporting freight to the aircraft for load into a bulk cargo compartment. These compartments do not hold the load device and are instead offloaded plane side into an appropriate section of the aircraft. These are known as “bulk loads” in the cargo aviation industry. Users can quickly select the ‘Bulk Load?’ option (FIG. 6A) to denote that the ULD is to be bulk loaded which then requires information to be entered concerning the weight of the load device. To account for this scenario, when the ULD identifier is entered and the ‘Bulk Load?’ option is selected the application can perform a lookup of information from a database on the standard-tare of the ULD type. To ensure accuracy, this information can be overridden to reflect the actual tare if it varies from the tare retrieved from the database. The actual tare is listed on all ULDs by the manufacturer as part of industry standard. Thus, the application can provide an easy and consistent way to cross-check accurate tare weights for a ULD during bulk loading of cargo.

The last pieces of information required in this section are the utilization and contents fields (see FIG. 6A). The utilization field by default is set to 25% increments and can be selected using the drop down or by utilizing a set of QR codes indicating the appropriate values. Some customers may want a more granular scale which can be specified during the installation process or configured at a later date if desired. As for the contents information, use of a catalog of QR codes for common items is suggested allowing the user to select the appropriate item from the catalog and scan in the information. Alternately, this field can accept typed values as well allowing customers to enter appropriate information. Some common items to include in a catalog include: “Bags and Boxes”, “Mail”, “Hazardous Materials”, “Small Packages”, etc.

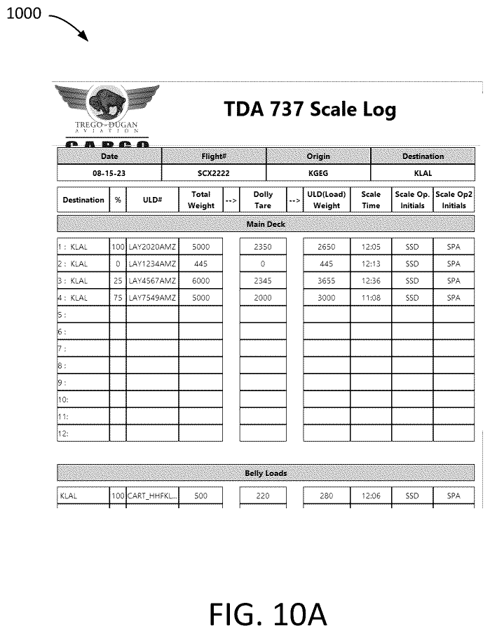

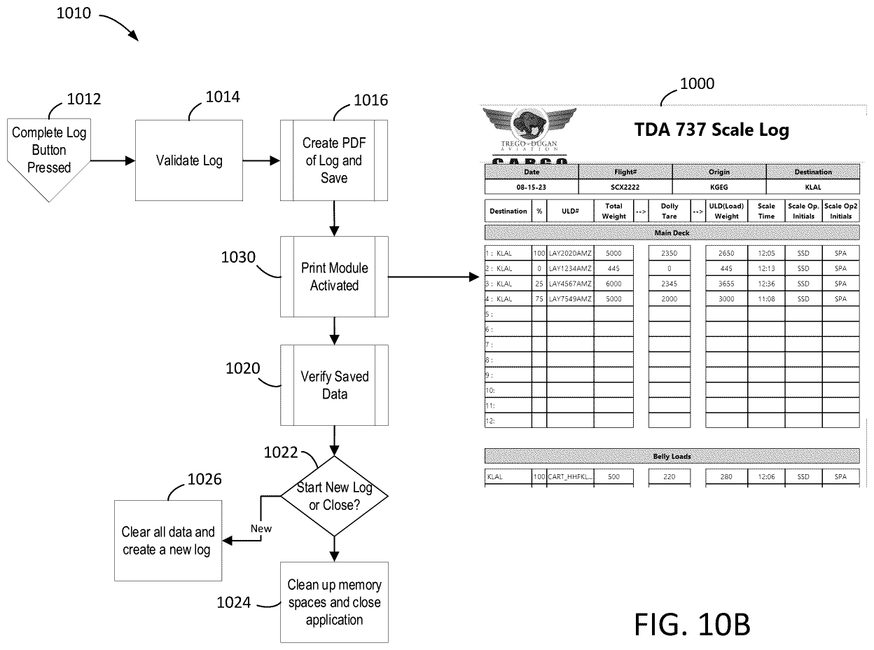

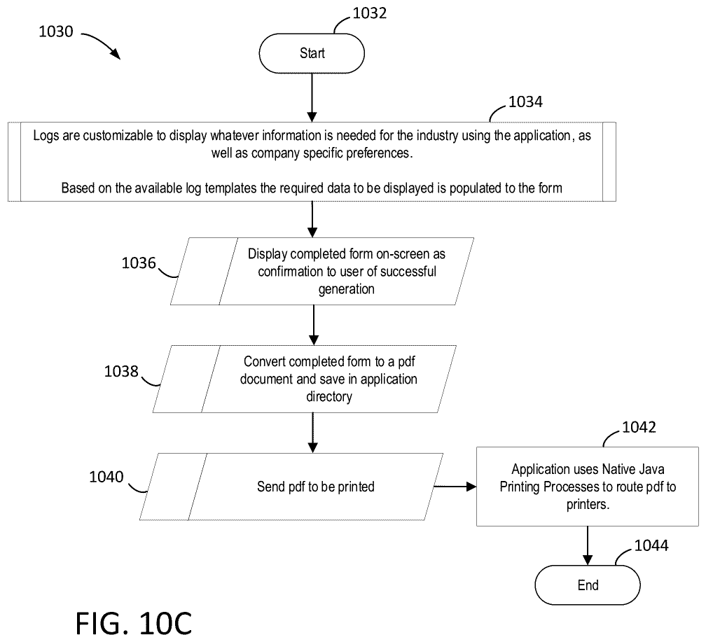

Once all information has been recorded the user will select the ‘Complete ULD’ button (see FIG. 6A) which will then determine that all required entries are present and in an appropriate format before generating a virtual ULD. This virtual construct can then be used to generate and print a placard as well as populate data onto the printable Scale Log as seen in FIG. 10A below. Also generated at this time is a unique QR code to allow a load planner to import information directly into a load planning software. This QR code prevents error in the entry of this information into the weight and balance software ensuring accurate and safe data for the flight. The QR code can be found on the printed placard to be included with the ULD as per industry standard, for example at block 690 of FIG. 6B. This QR code can be scanned directly from the placard, viewed and scanned from the on-screen display when the ULD is selected, details in the On-Screen Log Display of this document. Or for convenience all currently weighed loads can be displayed on screen by choosing the ‘View QR Codes’ option from the ‘View’ menu. Once selected, an onscreen display of all placards including their associated import code can be displayed and can be scrolled through to find the desired information.

Additionally, the virtual ULD can be utilized to display information in the on-screen log that updates in real-time as the user works through the weighing process. More details on that section below.

Finally, when all weighing activities are complete the user would select the ‘Complete Log’ button (see FIG. 6A) to close-out weighing activities for the flight. When selected, this can recheck each virtual ULD for any discrepancies, validate information about the flight and operators has been recorded to each ULD, and complete the required information on the printable scale log and print that log for use in verification of loads by agents planeside.

In some examples, the application may additionally and/or alternatively show other features in this area such as the displays showing current counts as well as maximum counts of ULDs based on the selected aircraft type. These can be updated dynamically by the application as ULDs are weighed to give operators information immediately without having to count individual entries which can lead to oversight and inaccurate information. There can also be a display indicating a particular ULD is selected utilizing the on-screen log. This information allows users to reexamine full details of a ULD if needed, as well as allowing the opportunity to remove the device from the log if needed due to any number of circumstances. Thus, changes and/or updates that can occur throughout the weighing process may be accurately accounted for, ensuring proper loads are considered when balancing the aircraft. This section can also display the import QR code for quick reference to import data into a load planning software suite.

The largest selection of the interface displays information about each until load devices weighed. The displayed data can be useful to load planners and scale operators to keep a visual tally of all ULDs weighed along with basic information for planning and timing purposes. The scale recording sheets are like the one shown in FIG. 10A where a division between main deck and bulk load items can be set. To maintain a format that most users may be accustomed to the log can break up the display of information based on configuration of the selected aircraft type.

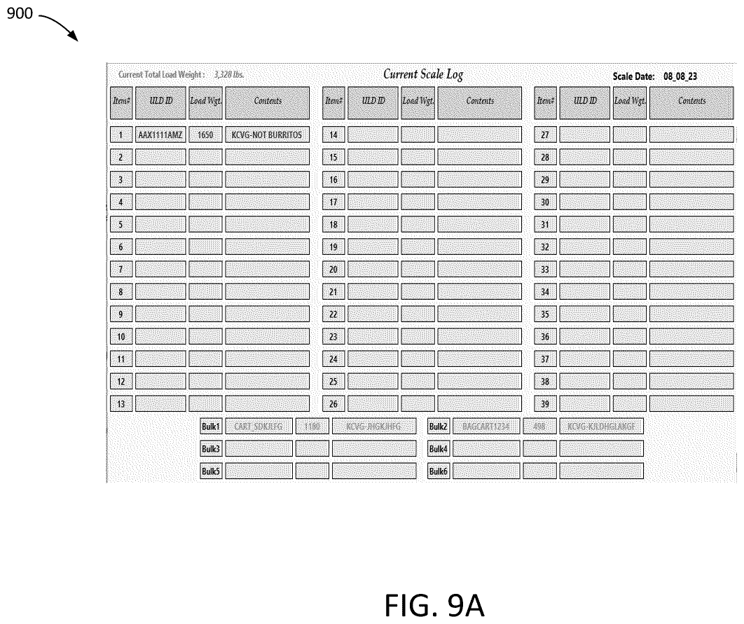

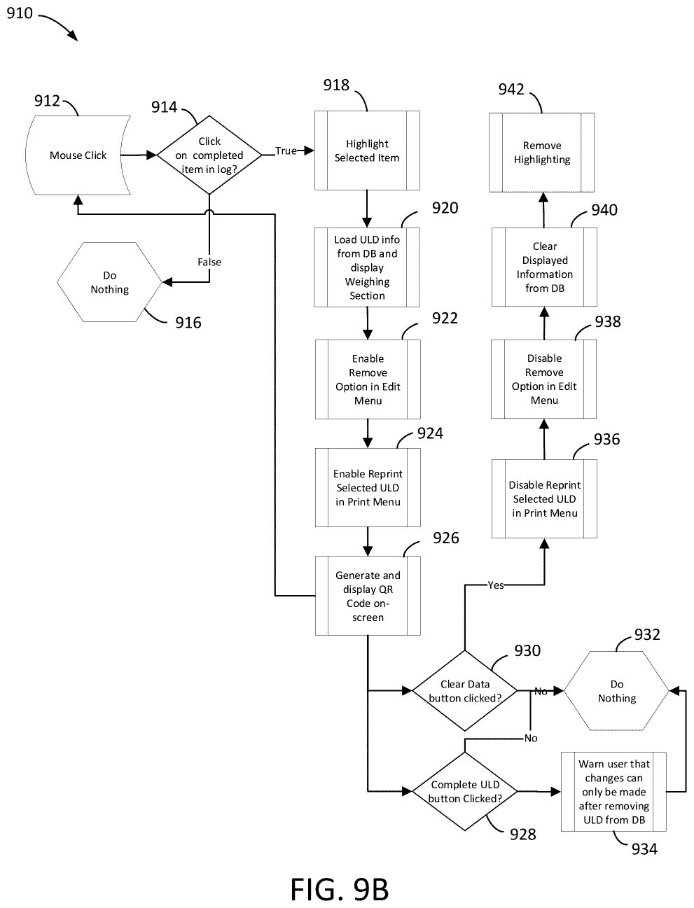

Entries for the on-screen display can be color coded by the application to highlight as a visual indication of the intended load area. Standard installation with the pre-loaded aircraft types can color code ULDs to be loaded as blue for main deck, purple for lower deck and yellow for bulk items. Color coding can help mitigate risk of placing loads in the wrong section by serving as a visual indication of the indented load area for each cargo weighed. See FIG. 9A. Additional color configurations can be added by end-users using the ‘Add AC Type’ feature.

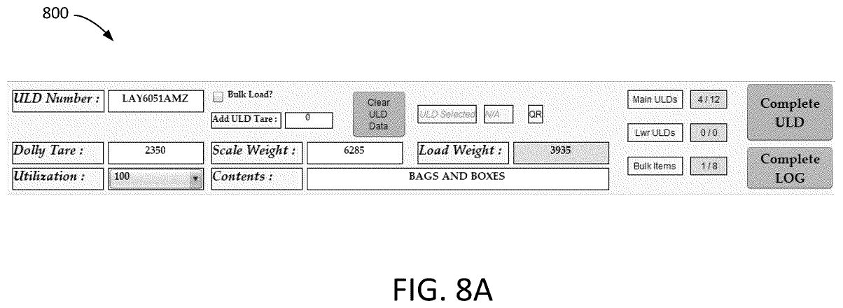

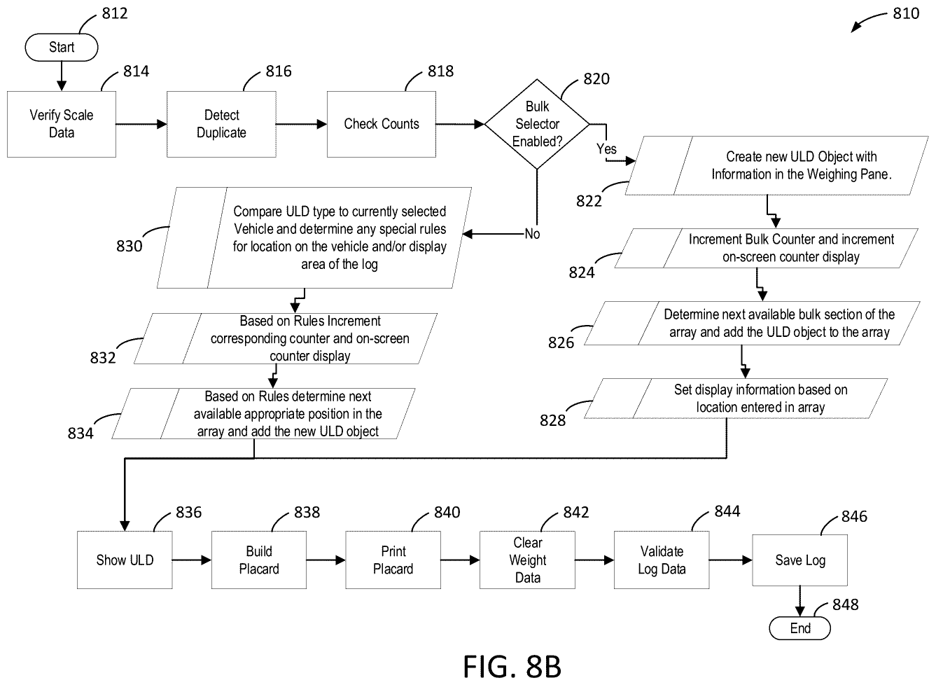

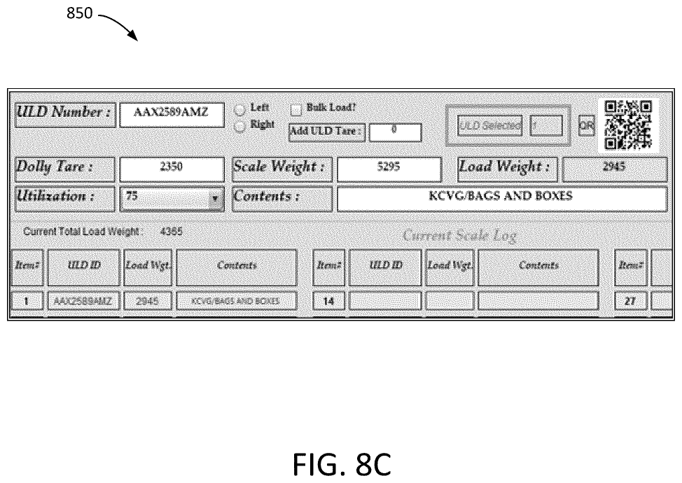

A portion of information can be displayed in the on-screen about each ULD, however by clicking, selecting, hovering over, or actuating any of the ULDs in the display it can display all information into the weighing section of the interface. When this information is reloaded the QR code used for importing into load planning software can also be displayed. Also note, as mentioned in the description about the weighing section of this document, that the selected ULD indicator will light up in red (see box showing “ULD Selected” in ULD display 850 of FIG. 8C). This call-out may be helpful to using the ‘Remove ULD’ function discussed later in this document. Thus, color coding information can aid in drawing user attention to specific areas of the GUI that can be important to accurate load data being considered during the weighing and balancing process.

Likewise, when selecting a bulk load item all information including the additional tare weight can be re-displayed on the GUI.

The on-screen log display section can be used to navigate through the weighed ULDs for the flight and to see/review information about them quickly. The display keeps items organized and color coded to easily find information during the load planning and scaling process. Further, with the elimination of having to recognize hand-written numerals or other transcription errors, this clean format ensures reliability of data and speeds confirmation of that data. Thus, the application provides accurate and up-to-date data of weighed ULDs that can enhance overall safety associated with a process required to load aircraft.

Another feature in the interface may be a display of the running total load weight. This may be important due to the fact that information provided by carriers always includes information about the maximum payload for each aircraft. Those maximum weights vary from aircraft to aircraft even when they are the same model. This may be important for flexibility in load planning purposes as new or modified flight releases or other flight paperwork provided by the carrier may need to be requested by the load planner if certain weights are exceeded or outside of the planned flight parameters. This display provides a method to quickly identify situations that may require contacting the carrier for new documents to be filed based on this value. The application can determine all loads weighed, such as determining the running total load, for reference against the maximum payload of the specified aircraft configuration.

The remove ULD feature allows the user to remove a weighed item quickly and safely from the scale log. There are many reasons this could occur such as the load device being bumped to an alternate flight. This feature can include a double-checking prompt to the user before allowing removal of the device. Also If a ULD is removed, the application can re-organize the on-screen display and re-determine the total load weight in real-time. Likewise, the application can update the final scale log printout to remove the ULD from being listed on the final scale log printout. This ensures safe and accurate information is available for consideration when balancing the aircraft.

Like the ‘File’, ‘Edit’ and ‘View’ menus described above the application has easy to find options for performing operations that may be required when completing a scale log. Some notable actions are the ‘Print’ menu where the user can reprint items such as the entire log, individual or all placards and the ‘Edit’ menu that allows the user to update information that is atypically or infrequently changed (like a flight number) due to an aircraft or route change. Features in a ‘Mode’ and ‘Help’ menu depicted below allow access to other functionality as well. The ‘Mode’ menu can allow future enhancements to allow the application flexibility to work in other sectors of the cargo industry. These enhancements can keep the same general flow of data but can modify the interface based on each industry requirement. The ‘Help’ menu gives the user easy access to a comprehensive user guide that is installed with the application. Additionally, it provides access to email support. This feature can retrieve pertinent information about the current state of the application allowing support personnel to view the log remotely to aid in any troubleshooting needs for end users.

Built into the application are multiple layers of error checking for common mistakes made by scale operators. If an error or mistake is determined by the application, the application can provide customizable error message pop-ups, such as by displaying a message in a portion of the GUI, to guide and/or assist the user through common mistakes before the data can be saved. Further, the application may prevent the user from continuing with the process until all errors and/or mistakes have been corrected. These features all contribute to a safer and more accurate set of data, which ultimately allows for proper aircraft balancing to occur. This increases safety. In some examples, the application may display one or more error pop-up notifications (see error pop-ups 590A, 590B in FIGS. 5C-D). The example pop-ups demonstrate the ability to be brief in the notification, or, more verbose depending on the error in order to help guide the users.

The application can be used in any setting where weighing of freight is required. It is particularly useful when tolerances are zero for inaccurate weights and/or data inputs. It provides consistent and accurate results. Although not limited to cargo aviation, the App's primary purpose is to assist in the weighing of loads bound for a cargo aircraft regardless of the type of cargo being transported. With customization, the Application can easily adapt to other sectors of the cargo industry such as railcars, cargo ships, tractor-trailers, etc. where weight considerations are key to the safe transport of goods. Use of the application in partnership with cargo carriers can increase safety.

The figures described below may contain one or more example implementations that may relate to the above disclosure. Further, aspects from one or more of the figures may be combinable with another figure.

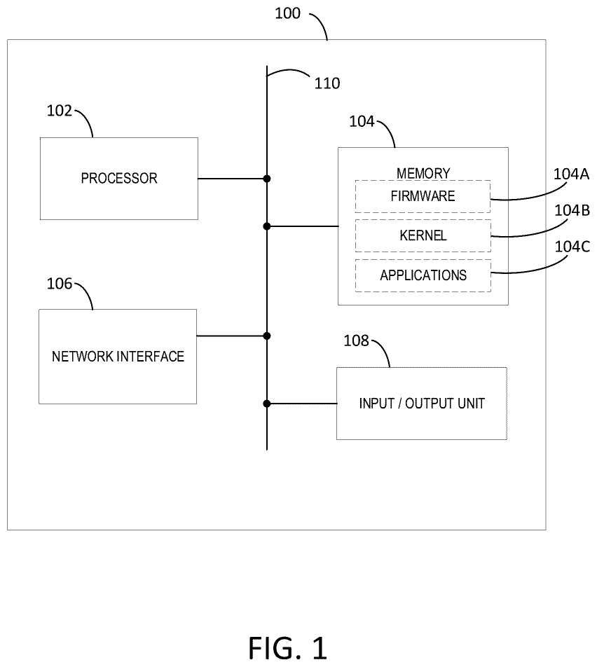

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

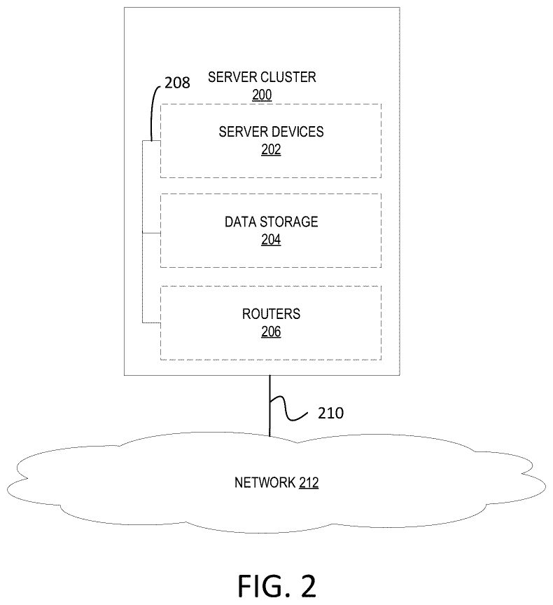

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, the extensible Markup Language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

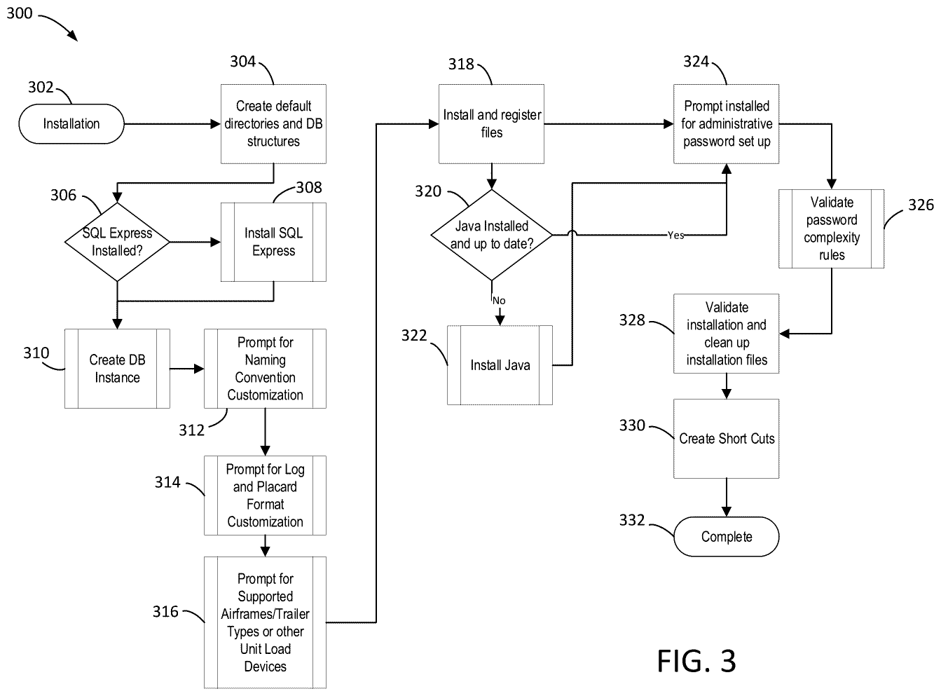

FIG. 3 illustrates an installation flow diagram 300 according to exemplary embodiments of the present disclosure. The installation flow diagram 300 may be used to install an application on a user device, such as an application that provides scanner based determination of cargo weight for determining and/or tracking cargo weight data. The installation 302 may begin by creating default directories and database (DB) structures 304. At block 306 the application may determine whether SQL Express is installed. If SQL Express is not installed the application may proceed to block 308 to install SQL Express. If SQL Express is installed the application may proceed to creating a database instance 310. When creating the database instance 310 the application may prompt the user for a customized naming convention 312; prompt the user for log and placard format customization 314; and/or prompt the user for supported airframes, trailer types, and/or other ULDs 316.

After receiving inputs from one or more of the blocks 312-316, such as inputs in the form of data files, the application may proceed to installing and registering the files 318. In some examples, the application may determine whether a software, such as Java, has been installed and is up to date 320. If it is determined that the software is not installed and/or not current the application may proceed to installing the software (e.g., Java) 322 before moving to block 324. If it is determined at block 318 that the software is installed and/or up to date the application may proceed to block 324. In other examples, the application may proceed directly to block 324 to install a prompt for an administrative password to be set up. The password may include one or more complexity rules/requirements, such as complexity rules/requirements regarding password length and/or special characters or numbers to satisfy a desired protection level. After the password has been set up in block 324 the application may validate that the password satisfies the password complexity rules 326. The application may then perform an installation validation and clean-up of the installation files 328 as well as creating short cuts 330 for one or more operations within the application before completing 332 the installation.

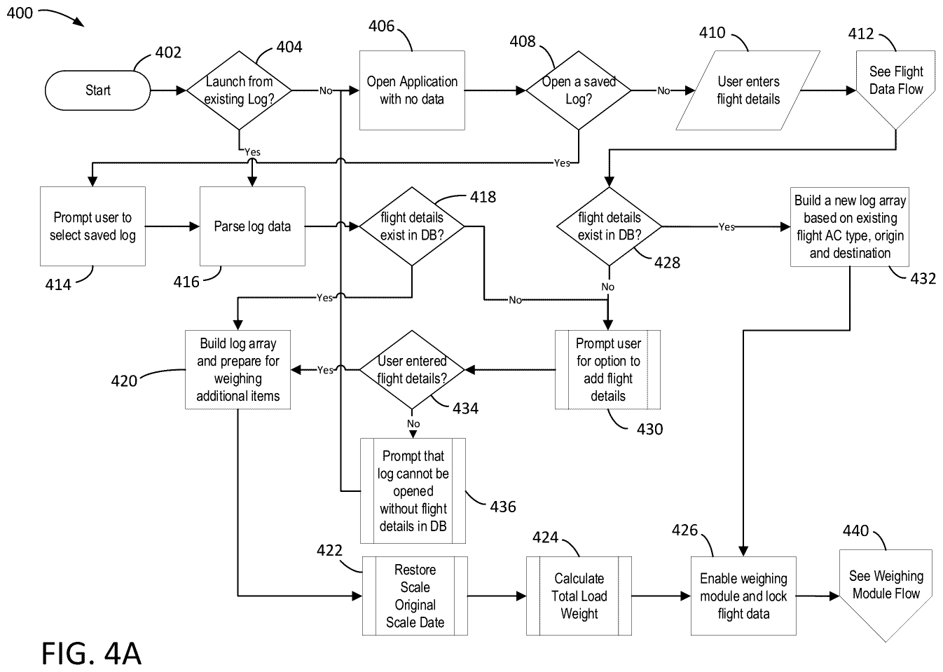

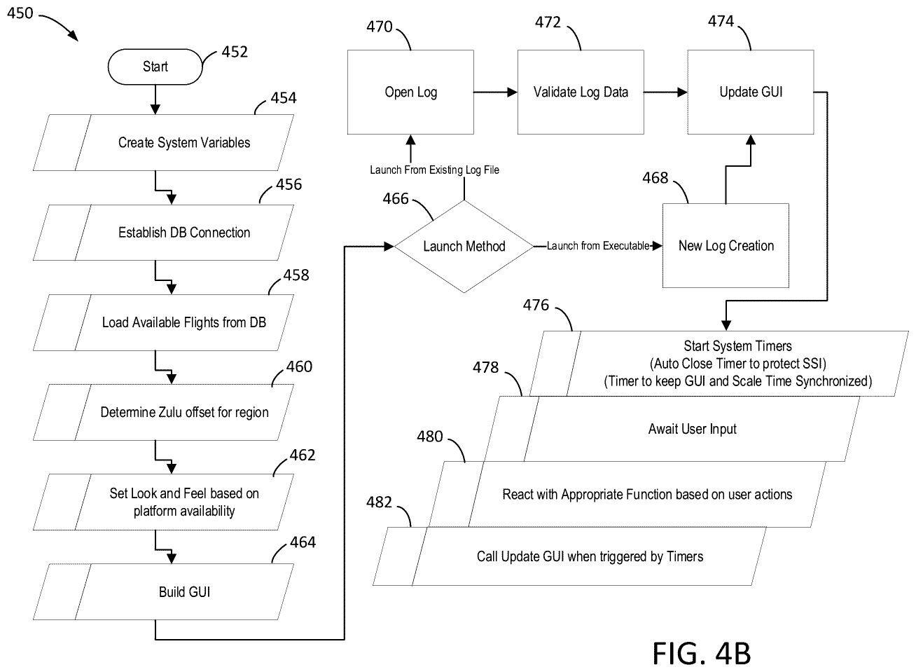

FIG. 4A illustrates an application launch flow diagram 400 according to exemplary embodiments of the present disclosure. At block 402 the application may start the launch process. Block 404 may involve determining whether to launch the application from an existing log, such as a previously saved log. If it is determined to launch the application from an existing log, block 416 may involve parsing log data before progressing to block 418. At block 418 the application may determine whether flight details exist in the database. Based on whether flight details exist in the database, the application may progress to either block 420 or block 430.

For example, if it is determined that flight details exist in the database, block 420 may involve building a log array and/or preparing the application for weighing of additional items. However, if flight details do not exist in the database block 418 may progress to block 430. At block 430 the user may be prompted for the option to add flight details. At block 434 the application may determine whether the user has entered flight details (e.g., block 430) before progressing to block 420. If block 434 is not satisfied, block 436 may involve prompting the user that a log cannot be opened without flight details in the database.

After the log array has been built and the application has prepared for weighing additional items at block 420, the application may proceed to block 422-426, which may involve restoring the scale to original scale date (block 422), calculating total load weight (block 424), and/or enabling the weighing module and locking flight data (block 426). At block 440 the application may initiate one or more weighing module flow operations described herein. For example, block 440 may involve one or more operations described with respect to FIGS. 6A-6B.

In examples where block 404 is not satisfied block 406 may involve opening the application with no data. At block 408 the user may be prompted for the option to open a saved log. If block 408 is satisfied, for example it is desired to open a saved log, block 414 may involve prompting the user to select a saved log before progressing to block 416. However, if block 408 is not satisfied, for example it is not desired to open a saved log, block 410 may involve the user entering flight details into the application. In such examples, one or more additional flow diagrams may be utilized at block 412 during entry of flight details. At block 428 the application may verify whether flight details exist in the database. If block 428 is not satisfied the application may progress to previously described block 430. If block 428 is satisfied, a new log array may be built based on existing flight aircraft type, origin, and/or destination may occur at block 432 prior to progressing to block 426.

FIG. 4B illustrates an application start-up flow diagram 450 according to exemplary embodiments of the present disclosure. The start-up flow diagram 450 begins (e.g., starts) at block 452. The application may create system variable at block 454, establish a database connection at block 456, load available flights from the database at block 458, determine a Zulu offset for a particular region at block 460, set look and feel based on platform availability at block 462, and/or build a graphical user interface (GUI) at block 464. When one or more of blocks 454-464 have been performed, block 466 may involve determining whether to launch from an existing log file or from an executable. If it is determined to launch from an existing log file, block 470 may involve opening the existing log file and block 472 may involve validating the log data.

At block 468 a new log may be created if it is determined at block 466 to launch from the executable. Blocks 472 and/or 468 may progress to block 474 which may involve updating the graphical user interface with data, such as existing or new log data. Block 476 may involve starting system timers, such as an auto close timer to protect sensitive security information (SSI) and/or a timer to synchronize the GUI and scale time. Utilizing the auto close timer may protect SSI from inadvertently being released which may increase the safety and/or security of the transportation process. The application may await user input at block 478, based on the users actions reach with an appropriate function at block 480, and/or when prompted by the timers update the GUI at block 482.

FIG. 5A illustrates an example on screen display of a flight data entry 500 according to exemplary embodiments of the present disclosure. The example on screen display of the flight data entry 500 may include information such as a flight number, an aircraft type, a flight origin, a flight destination, a load planner, a primary scale operator, a plane side agent (PSA), and/or a start scale log prompt. In some examples, the on screen display may be populated by the user, such as through a drop down selection tab, however in other examples one or more fields may be auto-populated based on a prior input from the user. For example, entry of the flight number may populate one or more of the aircraft type, the flight origin, and/or the flight destination.

FIG. 5B illustrates a flight data entry flow diagram 510 that may be used with the flight data entry 500 of FIG. 5A according to exemplary embodiments of the present disclosure. The flight data entry flow diagram 510 may begin at block 512 and progress to either block 514 or block 540. Block 514 may determine whether the user knows the applicable flight number. If the flight number is known to the user, block 518 may involve entering the flight number on the flight data entry 500. At block 518 the application may check the database to determine for the entered flight number. Block 520 may determine whether the entered flight number is in the database. Based on the determination at block 520 that the flight number is in the database, block 530 may use the flight number to populate one or more of the aircraft type, the origin, and/or the destination of the aircraft.

If it is determined at block 520 that the flight number is not in the database, block 522 may involve prompting the user to add the flight to the database. To add the flight to the database, blocks 524-528 may be performed. For example, at block 524 a start flight addition and/or removal tool may be launched. Block 526 may involve the user entering an origin, a destination, a flight number, and/or an airframe into the tool from block 524. The flight information may be added to the database at block 528 before proceeding to block 516 described above.

Block 532 may determine whether scale names have been entered. Based on a positive determination that scale names have been entered, block 534 may involve the user launching the “start scale log” button, depicted in the flight data entry 500. In such examples, all entries by the user may be revalidated and the user may be prompted with found errors and/or recommended solutions for the found errors. For example, block 536 may determine whether any errors are detected based on the entries to the scale log. Detected errors may return to the identified entry for resolution of the error items at block 538, while if no errors have been detected the application may create a new log file and/or enable the weighing module at block 570. The scale date may be recorded and/or locked at block 572. Block 574 may involve one or more processes illustrated and discussed with respect to FIG. 6B.

In some examples, it may be determined in block 532 that scale names have not been entered. In such examples, one or more of blocks 540-552 may be performed. For example, block 540 may involve the user entering the name of the load planner, block 544 may involve the user entering the name of the scale operator, and block 548 may involve the user entering the name of the plane side agent and/or verifier. Based on the entry of data from blocks 540, 544, and 548, blocks 542, 546, and 550, respectively, may be performed to parse the entered data (e.g., name) to generate initials and enter the generated initials into the respective field on the flight data entry 500. Block 552 may determine whether the flight number has already been entered into the application. Based on a positive determination that the flight number has already been entered, the application may progress to block 534, while a negative determination may progress to block 516.

In some examples, the application may include an active menu item listener. In such examples, it may be determined whether a menu item has been selected by the user. If it is determined that no menu item has been selected then no action may be performed. If it is determined that at least one menu item has been selected, the application may direct the user to the at least one selected menu items. Within examples, selection of a particular menu item may cause the application to perform one or more operations associated with the selected menu item. In some examples, one or more operations described herein may incorporate the active menu item listener to direct the user to the selected menu item and/or perform relevant operations based on the selected menu item.

FIG. 6A illustrates an example on screen display of a weighing module data entry 600 according to exemplary embodiments of the present disclosure. The on screen display of the weighing module data entry 600 may include a ULD number, a dolly tare, a scale weight, a load weight, a utilization, a contents field, a bulk load selection, and an add ULD tare field. The on screen display may further include one or more interactive features (e.g., clickable buttons) that the user may actuate to perform an action, such as a clear ULD data feature, a complete ULD feature, and/or a complete log feature, which may each perform additional one or more actions discussed herein.

FIG. 6B illustrates a weighing module data entry flow diagram 610 that may be used with the weighing module data entry 600 of FIG. 6A according to exemplary embodiments of the present disclosure. The weighing module data entry 600 may begin at block 612 which may involve creating and/or opening a log. Block 614 may involve the user scanning a bar code of a ULD. At block 616 the application may launch a ULD name/type verification module. For example, scanning of the bar code of the ULD may initiate the application to perform one or more operations in the ULD name/type verification module. At block 618 the application may determine whether the scanned bar code of the ULD is valid. If it is determined that the bar code is not valid, the application may return to block 614. If it is determined that the scanned bar code is valid, the application may proceed to block 620.

Block 620 may involve the user scanning a bar code of a dolly tare weight. Block 622 may determine whether the scanned dolly tare weight is a valid numerical value. If it is determined that the scanned dolly tare weight is not a valid numerical value, the application may return to block 620. Block 615 may involve the user scanning and/or entering a scale weight from a scale readout. At block 617 the application may determine whether the scale weight entered and/or scanned is a valid numerical value. If it is determined that the scale weight is not a valid numerical value, the application may return to block 615. In some examples upon satisfying either block 622 and/or block 617 the application may proceed to block 624.

For example, if it is determined that the scale weight is a valid numerical value and/or if it is determined that the scanned dolly tare weight is a valid numerical value, block 624 may involve determining whether a tare, a scale, and a ULD tare for bulk have all been entered. If one or more of block 624 are not satisfied, block 628 may involve returning to a current step in progress. For example, the application may return to block 620 and/or block 615. If block 624 is satisfied (e.g., tare, scale, and ULD tare for bulk have all been determined to be entered), block 626 may involve calculating a load weight. At block 670 the application may verify that the load weight is not above/below a minimum and/or maximum amount for the ULD type and/or selected vehicle (e.g., airframe). Block 670 may also involve prompting the user with one or more errors and/or possible solutions. In some examples, block 670 may record the calculation in an applicable field on the on-screen display.

Block 619 may involve the user selecting a utilization percentage from a drop down menu and/or scanning a utilization percentage barcode. At block 630 the application may determine whether the utilization percentage is a non-zero number, where a zero percentage may indicate an empty ULD. If it is determined that the utilization percentage is zero, block 634 may involve starting an empty ULD processing operation. If it is determined that the utilization percentage is a non-zero number, block 632 may involve the user scanning and/or entering content information for the ULD.

At block 636 the application may involve scanning and/or entering a key recorded with activation of the complete ULD button. In some examples, actuation of the complete ULD button may indicate that the user has completed weighing operations of the particular ULD. Block 638 may involve one or more operations to complete ULD validation. For example, all entries may be validated and/or re-verified at block 638. Block 640 may involve determining whether all entries are valid. If it is determined that one or more entries are not valid, block 641 may involve returning to a specified item with an error detected message. In some examples, the user may be prompted with the issue and/or possible solutions. If it is determined that all entries are valid, block 642 may involve activating a QR code generator module as described herein. At block 644 the application may record one or more ULDs in the database and/or display the one or more ULDs in a log on the on-screen display. Block 646 may involve activating a print module. In some examples, the print module may generate an image and/or document to be printed, such as the image shown at block 690. Block 690 may contain information entered during one or more operations described herein and/or a scannable QR code.

At block 648 the application may add weights of all completed ULDs to recalculate a total load weight. Block 650 may involve determining whether the user is done performing weighing operations. If it is determined that weighing operations are complete, block 652 may involve actuating (e.g., clicking, selecting, hovering over, or actuating) a complete log button. If it is determined that weighing operations are not complete, the application may return to block 614. In some examples, the user may have the option to clear ULD data from the log. For example, block 666 may involve the user clearing (e.g., removing) ULD data through clicking, selecting, hovering over, or actuating a button, such as a clear ULD data button.

FIG. 6C illustrates an example flow diagram that may be used to generate the placard 690 of FIG. 6B, and further illustrated in FIG. 6D, according to exemplary embodiments of the present disclosure. To generate the placard 690 the process may begin at block 691 the progress to block 692. Placards may be customizable to display desired information pertaining to a respective industry and/or information or preferences of a specific user. Block 692 may include populating an available placard and/or form to display the desired information. In various examples, block 692 may be used to display the current log on the display screen without performing additional block 693-697.

At block 693 a QR code or a bar code may be generated. Block 694 may involve displaying the completed form on an on-screen display of a user device. Displaying the completed form may serve as a confirmation to the user that the generation of desired information has been successful. At block 695 the completed form from block 694 may be converted to a suitable document format, for example a pdf document, and saved in a directory of the application. The document, such as the pdf document, may be printed at block 696. In some examples, the application may utilize a Java printing process at block 697 to route the document to the printer for printing before ending the operation at block 698.

FIG. 6E illustrates an example flow diagram for verifying scale data that may be used with block 670 of FIG. 6B according to exemplary embodiments of the present disclosure. The verifying scale data flow diagram may begin at block 671. At block 672 the application may determine whether all fields contain an entry. If it is determined that not all fields contain entries, block 673B may involve notifying the user that not all fields contain entries and/or identifying the first missing entry. Block 677A may involve setting a return value to false to indicate a failed validation attempt. However, if it is determined that all fields contain entries, block 673A may detect for the presence of duplicate entries.

Block 674 may involve determining whether there are any empty ULDs included in the entered scale data. If it is determined that there is one or more empty ULDs, block 675A may involve determining whether a weight entered for the ULD is appropriate for an empty ULD of the ULD type. If it is determined that the weight is appropriate, block 676A may involve setting a return value to true. If it is determined that the weight is not appropriate, block 676B may involve notifying the user that the entered weight may be above/below an empty weight expectation for the ULD type. In some examples, the application may proceed from block 676B to block 673B, while in other examples the application may proceed from block 676B to block 677A. Where it is determined at block 674 that no empty ULDs are included in the entered scale data, block 675B may determine whether any duplicate entries exist. If it is determined that one or more duplicate entries exist, the application may proceed to previously described block 677A.

If it is determined that no duplicate entries exist, block 677B may involve determining whether the weight is represented as a positive number. If it is determined that the weight is not a positive number, block 678B may involve notifying the user that a negative load is not possible and to check one or more entries to proceed. If it is determined that the weight is represented as a positive number, block 678A may determine whether the weight is above a ULD minimum base weight. If it is determined that the weight is not above the ULD minimum base weight, block 679B may notify the user that the load weight cannot be below the minimum weight of the ULD type. If it is determined that the weight is above the ULD minimum base weight, the application may proceed to block 679A.

At block 679A the application may determine whether one or more entries represented by the scale data are bulk loads. If bulk loads are determined to be present, block 680B may involve determining whether the ULD is allowed on the vehicle (e.g., aircraft) type selected. If the ULD is not allowed on the selected vehicle type, block 682 may involve notifying the user that the ULD does not fit on the selected vehicle. If it is determined that the ULD is allowed on the selected vehicle type, block 680A may determine whether one or more remarks meet an expected format. If the remarks do not meet the expected format, block 681B may involve notifying the user that the remarks/comments do not match expectations and prompt the user with suggestions, for example by focusing on one or more of the comments filed. If the remarks are determined to meet the expected format, block 681A may determine whether a utilization is set to a non-zero value. If the utilization is not set to a non-zero value, block 683 may involve notifying the user of an invalid utilization selection, for example by focusing on a particular utilization for correction. If it is determined that the utilization is set to a non-zero value, the application may proceed to previously described block 676A.

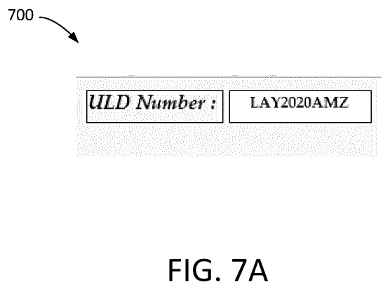

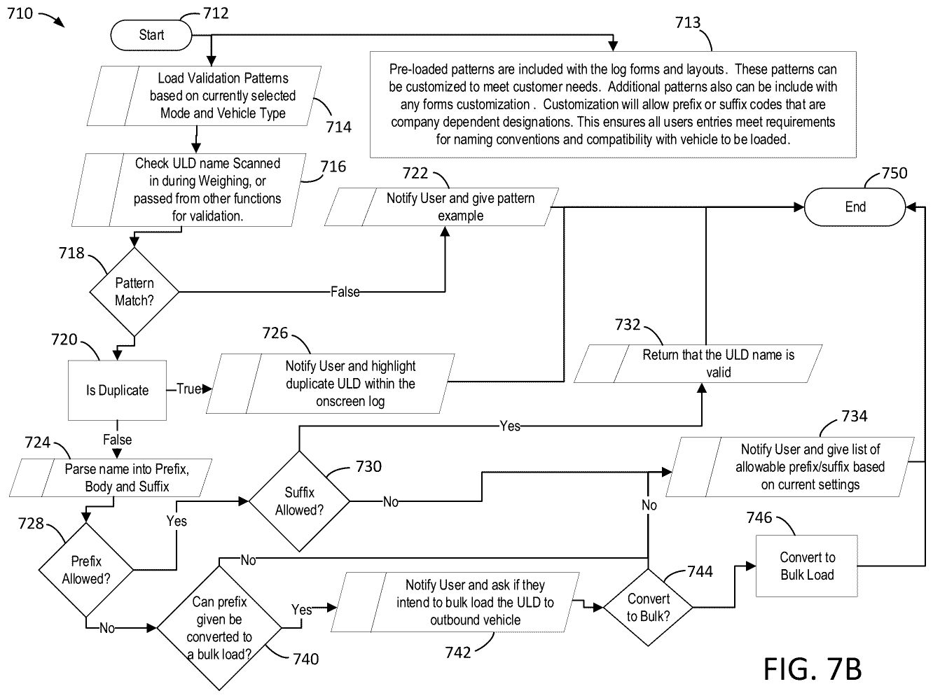

FIG. 7A illustrates an example on screen display of a ULD type/name verification 700 according to exemplary embodiments of the present disclosure. The on screen display of the ULD type/name verification 700 may include the ULD number, for example, which may include a unique alphanumeric string that identifies a particular ULD being used.

FIG. 7B illustrates a ULD type/name verification flow diagram 710 that may be used with the ULD type/name verification 700 of FIG. 7A according to exemplary embodiments of the present disclosure. The ULD type/name verification flow diagram 710 may begin at block 712 and progress to block 714 which may base load validation patterns on a currently selected mode and/or vehicle type. In some examples, prior to progressing to block 714, pre-loaded patterns may be included with the log forms and layouts at block 713. The patterns may be customized or based on desired customer preferences and/or needs. For example, additional patterns, prefix codes, and/or suffix codes may be desired by the customer for inclusion.

Block 713 may ensure that entries by the user meet desired customer requirements or preferences, such as naming conventions and compatibility with a vehicle to be loaded. At block 716 the application may validate the ULD name, which may be scanned in during weighing or received from one or more functions described herein. At block 718 the application may determine whether the ULD name is valid. If the ULD name is determined not to be valid, the user may be notified and an example pattern may be given to the user as a suggestion at block 722. If the ULD name is determined to be valid, block 720 may involve determining whether any ULD name duplicates exist. The user may be notified of the duplicate ULD, such as through highlighting of the duplicate ULD on the on-screen log, at block 726. If no duplicates are detected, block 724 may parse the ULD name into one or more sub-components, such as prefix, body, and suffice. At block 728 and block 730 the application may check whether the customer settings allow for the parsed prefix to be used. If it is determined that the parsed suffix is valid and/or allowed, block 732 may involve indicating that the ULD name is valid before ending the flow diagram at block 750.

Depending whether block 728 or block 730 determines that the ULD name prefix is not allowed, the application may progress to either blocks 740 or 734. Block 740 may involve determining whether the prefix is convertible to a bulk load. If yes, the user may be notified as to whether the user intends to bulk load the ULD to an outbound vehicle at block 742. Block 744 may involve determining whether to convert the ULD to the bulk load and if yes the ULD may be converted to the bulk load at step 746. If it is determined not to convert the ULD to the bulk load, the user may be notified at block 734 of the determination and given a list of allowable prefix/suffix based on the current user settings.

FIG. 8A illustrates an example on screen display of a ULD completion verification 800 according to exemplary embodiments of the present disclosure. In some examples, the screen display of the ULD completion verification 800 may be a populated version of the screen display of a ULD type/name verification 700 shown in FIG. 7A.

FIG. 8B illustrates a ULD completion verification flow diagram 810 that may be used with the ULD completion verification 800 of FIG. 8A according to exemplary embodiments of the present disclosure. The completion verification flow diagram 810 begins at block 812. Blocks 814-818 may respectively involve verifying scale data, determining whether duplicate data is present or has been entered, and checking the counts (e.g., item count). At block 820, the application may determine whether a bulk selector is enabled, such as determining whether the user has selected the bulk load box shown in FIG. 8A. If it is determined that the bulk selector is enabled, one or more of blocks 822-828 may be performed. At block 822 the application may create a new ULD object with information from the weighing pane. At block 822 the application may increment the bulk counter and increment the on-screen (e.g., display screen) counter display. At block 826 the application may determine a next available bulk section of the array and add the ULD object to the array. At block 828 the application may set display information, such as information to be shown on the display screen, based on a location entered in the array.

If it is determined at block 820 that the bulk selector is not enabled one or more of blocks 830-834 may be performed. Block 830 may involve comparing a ULD type to the currently selected vehicle and determining any special rules for location/placement on the vehicle and/or display area of the log. Block 832 may involve incrementing a corresponding counter and the on-screen counter display. Block 834 may involve determining a next available appropriate position in the array and/or adding the new ULD object to the appropriate position. In some examples, block 832 and 834 may be based on one or more predetermined rules, such as system or customer imposed rules and/or preferences.

Block 836 may involve showing the ULD, such as showing the ULD on the display screen. Block 838 may involve building the placard, such as building the placard from information entered during one or more actions described herein. At block 842 the application may print the placard from block 838. Block 842 may involve clearing the weight data and block 844 may involve validating the log data. The application may save the log at block 846 prior to ending flow operations at block 848.

FIG. 9A illustrates an example on screen display of log interactions 900 according to exemplary embodiments of the present disclosure. The screen display of log interactions 900 may include one or more rows and/or columns that may display information relating to a current scale log such as item number, ULD ID, load weight, and contents. The screen display of log interactions 900 may also display a current total load weight, a scale date (e.g., a date the scale is used to facilitate entering information in the scale log), and one or more rows and/or columns that indicate bulk loads to be included.

FIG. 9B illustrates a log interactions flow diagram 910 that may be used with the log interactions 900 of FIG. 9A according to exemplary embodiments of the present disclosure. The log interactions flow diagram 910 may begin at block 912 with the user clicking, selecting, hovering over, or actuating a completed item in the log. Block 914 may determine whether a completed item in the log has been selected (e.g., clicked on). If no completed item has been selected, block 916 may perform no action. However, if it is determined that a completed item has been selected, at block 918 the selected item may be highlighted. Block 920 may involve loading the ULD information from the database and displaying the weighing section. At block 922 the application may enable a remove option in an edit menu. At block 924 the application may enable a reprint of the selected ULD in a print menu. Block 926 may involve generating and displaying a QR code on the display screen.

In some examples, block 930 may determine whether the user has selected a clear data button. If the clear data button has not been selected block 932 may involve performing no action. If it is determined that the clear data button has been selected, one or more of blocks 936-942 may be performed. At block 936 the application may disable reprint of the selected ULD in the print menu. Block 938 may disable the remove option in the edit menu, previously enabled at block 922. At block 940 the application may clear the displayed information from the database. Block 942 may remove highlighting from the selected item, previously highlighted at block 918. In various examples, block 928 may determine whether a complete ULD button has been selected. If the complete ULD button has been selected, block 934 may involve indicating to the user, such as through a warning pop-up, that changes can only be made after removing the ULD from the database. If the complete ULD button has not been selected then no action may be performed at block 932.

FIG. 10A illustrates an example on screen display of a log file 1000 according to exemplary embodiments of the present disclosure. The screen display of the log file 1000 may include one or more rows and/or columns that display information such as a date, a flight number, an origin, a destination, a percentage, a ULD number, a total weight, a dolly tare, a ULD (load) weight, a scale time, a first scale operator's initials, a second scale operator's initials, and which location on a vehicle the ULD corresponds to (e.g., main deck or belly loads).

FIG. 10B illustrates a log file flow diagram 1010 that may be used with the log file 1000 of FIG. 10A according to exemplary embodiments of the present disclosure. The log file flow diagram 1010 may begin at block 1012 with a selection (e.g., clicking, selecting, hovering over, or actuating) of the complete log button. At block 1014 the application may validate the log. Block 1016 may involve creating a pdf of the log and saving the log data. A print module may be activated at block 1030, which may display and/or print the log file 1000 (FIG. 10A). The saved data, such as from block 1016, may be verified at block 1020. At block 1022 the application may determine whether to start a new log or close the current log. If it is determined to start the new log, block 1026 may involve clearing all data and creating the new log. If it is determined not to start the new log, block 1024 may involve cleaning up memory spaces and closes the application.

FIG. 10C illustrates an example log printout generation flow diagram 1030 that may be used with block 1030 of FIG. 10B according to exemplary embodiments of the present disclosure. The log printout generation flow diagram 1030 may begin at block 1032. Block 1034 may involve populating the form with required log data that is to be displayed. In some examples, the required log data that is populated to the form may be based on one or more of the available log templates. The logs may be customizable to display industry specific information and/or specific preferences from the customer. In some examples, a similar process may be used to display a current log on screen. At block 1036 the application may display the completed form on-screen, such as on the display screen, which may serve as a visual confirmation to the user of a successful generation. At block 1038 the application may convert the completed form to a suitable format, such as a pdf document, and save the data in the application directory. The suitable document (e.g., pdf document) may be sent to a printer for printing at block 1040. In some examples, at block 1042 the application may utilize native Java printing processes, or another suitable printing process, to route the suitable document to the printer. The flow diagram 1030 may end operations at block 1044.

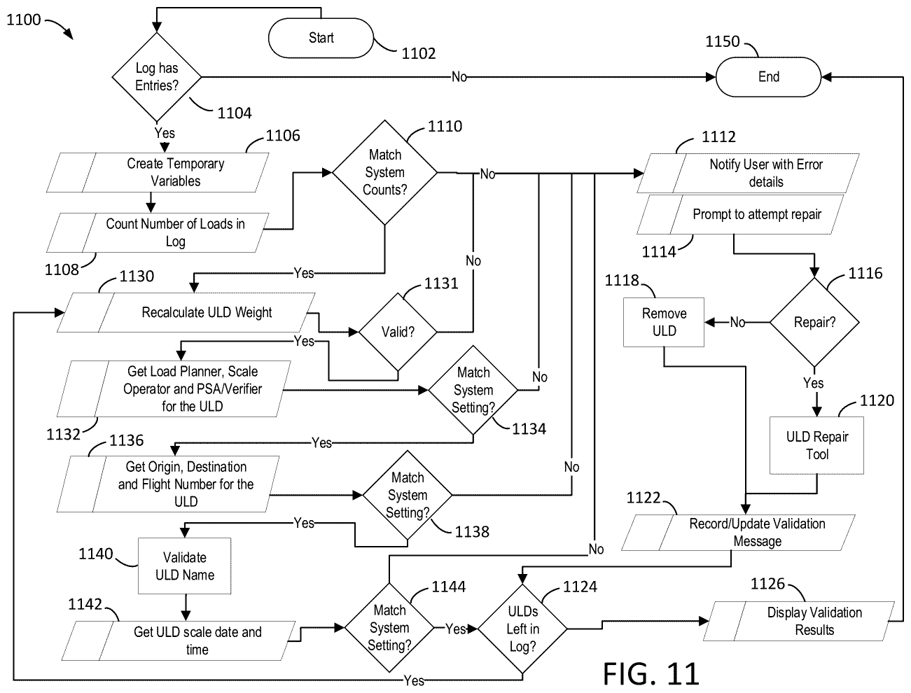

FIG. 11 illustrates a log data validation flow diagram 1100 according to exemplary embodiments of the present disclosure. The log data validation flow diagram 1100 may begin at block 1102 and proceed to block 1104. At block 1104 the application may determine whether the log contains one or more entries. If no entries are contained in the log, the operations may end at block 1150. If it is determined that one or more entries are contained in the log, block 1106 may create temporary variables and block 1108 may count a number of loads contained in the log. At block 1110 the application may determine whether the number of loads in the log from block 1108 matches a system count. If it is determined that the number of loads in the log matches the system count, block 1130 may recalculate the ULD weight. At block 1131 the application may validate the recalculated ULD weight. If block 1131 is satisfied, block 1132 may receive information such as the load planner, the scale operator, and the PSA/verifier for the ULD for validation.

Block 1138 may involve determining whether the received information from block 1136 matches one or more system settings. If the received information matches system settings, block 1140 may validate the ULD name. At block 1142 the application may receive information such as the ULD scale date and/or time. Block 1144 may verify that the received information from block 1142 matches system settings. If the received information matches system settings block 1124 may determine whether any ULDs are remaining in the log. If no ULDs remain in the log block 1126 may display the validation results. If block 1124 determines that one or more ULDs remain in the log, the application may return to block 1130.

In some examples, one or more of blocks 1110, 1131, 1134, 1138, and/or 1144 may not be satisfied (e.g., return a “no” response). In such examples, the application may proceed to block 1112. Block 1112 may involve notifying the user with error details determined from one or more of blocks 1110, 1131, 1134, 1138, and/or 1144. Block 1114 may involve prompting the user to attempt to repair or resolve the detected error. At block 1116 the application may determine whether a repair is desired. If a repair is not desired block 1118 may remove the ULD, such as remove the ULD causing the error from the log, and block 1122 may record and/or update a validation message. If it is determined that a repair is desired, block 1120 may involve launching a ULD repair tool before proceeding to block 1122.

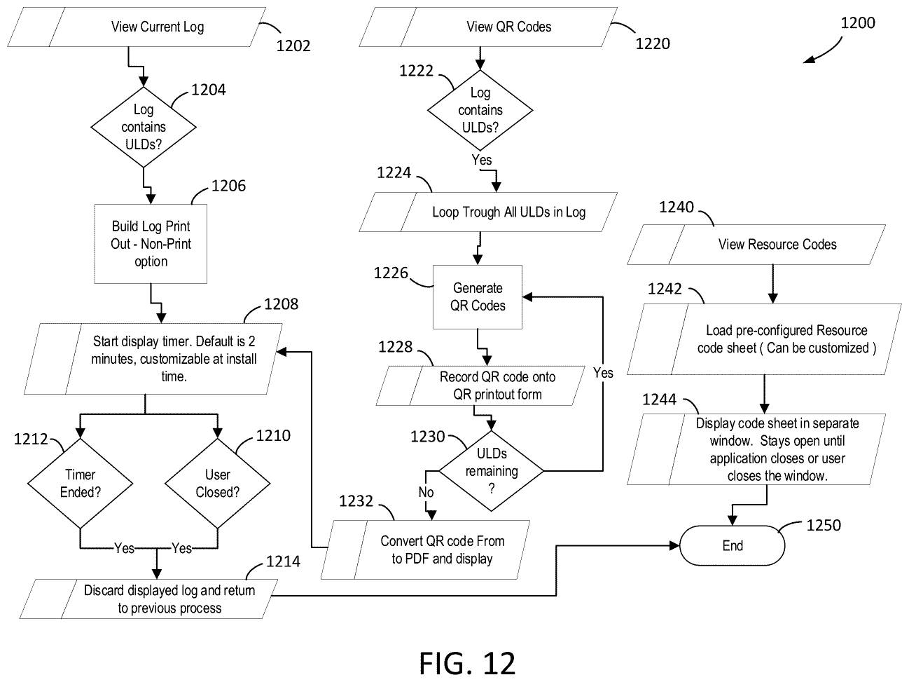

FIG. 12 illustrates a view menus flow diagram 1200 according to exemplary embodiments of the present disclosure. Block 1202 may involve viewing the current log. At block 1204 the application may determine whether the log contains one or more ULDs. At block 1206 the application may build a log print out. In some examples, block 1206 may include a non-print option. At block 1208 the application may launch (e.g., start) a display timer. In some examples, the timer may have a set default time, such as a two minute timer. However, in other examples the display timer may be customized based on desired customer or industry preferences. Block 1212 may involve determining whether a timer has ended. For example, an internal timer may begin to run upon viewing of the current log and upon satisfying of the timer the application may perform one or more additional actions. For example, block 1214 may involve discarding the displayed log and returning to a previous process. Block 1210 may involve determining whether the user has closed the view current log and if satisfied may proceed to block 1214 prior to ending operations at block 1250.

At block 1220 the application may include viewing one or more QR codes. At block 1222 the application may determine whether the log contains one or more ULDs. If it is determined that the log contains one or more ULDs, block 1224 may involve looping through all ULDs in the log. At block 1226 the application may generate QR codes, such as generating one or more QR codes based on the information contained in the log. The QR codes may be recorded onto a QR printout form at block 1228. At block 1230 the application may determine whether there are any remaining ULDs. If it is determined that there are remaining ULDs the application may return to block 1226. If it is determined that no ULDs remain, block 1232 may involve converting the QR code form to a suitable document, such as a pdf document, and displaying the converted document to the user.

Block 1240 may involve viewing one or more resource codes. At block 1242 the application may load a pre-configured resource code sheet. In some examples, the pre-configured resource code sheet may be customized based on industry and/or customer preferences/requirements. At block 1244 the application may display the code sheet in a separate window. The window may stay open until the application closes (e.g., terminates) and/or the user closes the window.

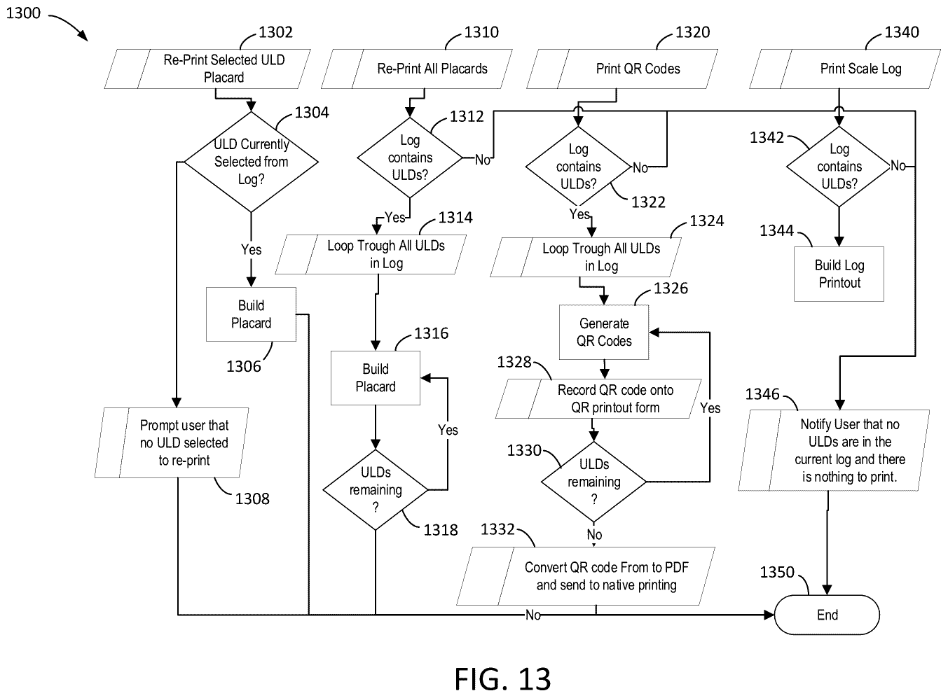

FIG. 13 illustrates a print menu module flow diagram 1300 according to exemplary embodiments of the present disclosure. Block 1302 may involve re-printing a selected ULD placard. At block 1304 the application may determine whether a ULD is currently selected from the log. If no ULD is currently selected from the log, block 1308 may involve prompting the user that no ULD has been selected to re-print. If it is determined that a ULD is currently selected from the log, block 1306 may involve building the placard. At block 1310 the application may re-print all placards. Block 1312 may involve determining whether the log contains one or more ULDs. If it is determined that the log contains one or more ULDs, at block 1314 the application may loop through all ULDs in the log. At block 1316 the application may build the placard.

Block 1318 may determine whether there are any remaining ULDs and if satisfied proceed to block 1316. If block 1318 is not satisfied, for example it is determined that there are no remaining ULDs, the application may end at step 1350. At block 1320 the application may print one or more QR codes. An example QR code is illustrated at block 690 of FIG. 6B. In some examples, each of the one or more QR codes may include information pertaining to a respective ULD. However, in other examples the one or more QR codes may include information relating to one or ULDs. The QR codes may function to allow relevant ULD information to be received by another device and/or application, such as a third party application. In some examples, the formatting of the one or more QR codes may be customized to correspond to one or more required fields of the third party application. Block 1322 may involve determining whether the log contains one or more ULDs. If it is determined that the log contains one or more ULDs, block 1324 may involve looping through all ULDs in the log. At block 1326 the application may generate the one or more QR codes. Block 1330 may involve determining whether there are any remaining ULDs and if satisfied proceed to block 1326. If block 1330 is not satisfied, for example it is determined that there are no remaining ULDs, block 1332 may be performed.

At block 1332 the application may convert the one or more QR codes to a suitable document, such as a pdf document, and send the one or more converted QR codes to a printer. At block 1340 the application may print a scale log. Block 1342 may involve determining whether the log contains one or more ULDs. If it is determined that the log contains one or more ULDs, block 1344 may involve building a log printout. In some examples, it may be determined in one or more of block 1312, 1322, and/or 1342 that the log does not contain a ULD. In such examples, block 1346 may involve notifying the user that no ULDs are in the current log and thus there is no information for which a printing operation may be performed for.

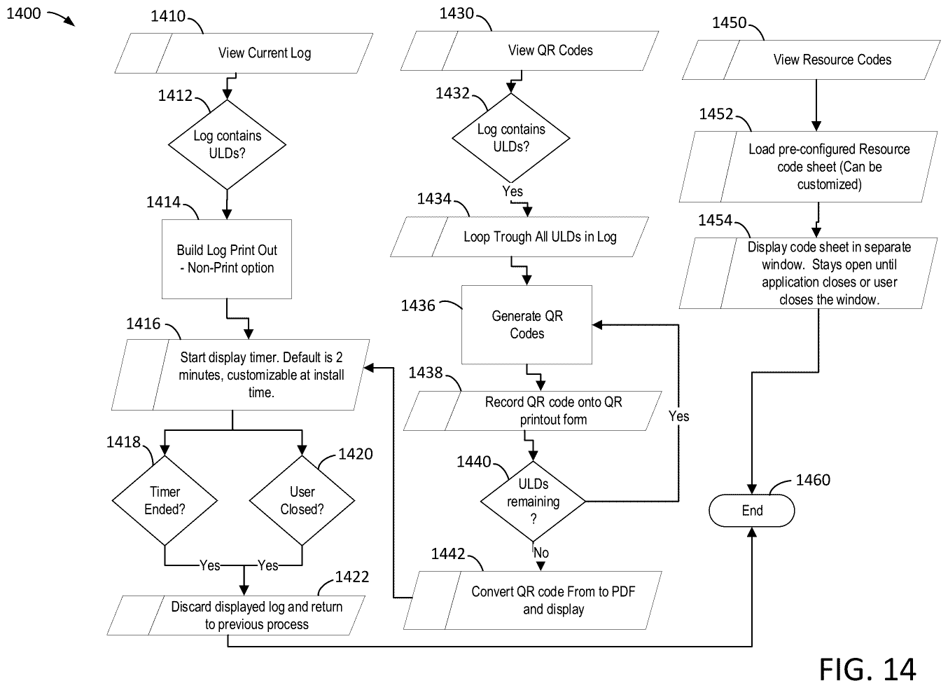

FIG. 14 illustrates a view menus flow diagram 1400 according to exemplary embodiments of the present disclosure. Block 1410 may involve viewing the current log. At block 1412 the application may determine whether the log contains one or more ULDs. At block 1414 the application may build a log print out. In some examples, block 1414 may include a non-print option. At block 1416 the application may launch (e.g., start) a display timer. In some examples, the timer may have a set default time, such as a two minute timer. However, in other examples the display timer may be customized based on desired customer or industry preferences. Block 1418 may involve determining whether a timer has ended. For example, an internal timer may begin to run upon viewing of the current log and upon satisfying of the timer the application may perform one or more additional actions. For example, block 1422 may involve discarding the displayed log and returning to a previous process. Block 1420 may involve determining whether the user has closed the view current log and if satisfied may proceed to block 1422 prior to ending operations at block 1460.

At block 1430 the application may include viewing one or more QR codes. At block 1432 the application may determine whether the log contains one or more ULDs. If it is determined that the log contains one or more ULDs, block 1434 may involve looping through all ULDs in the log. At block 1436 the application may generate QR codes, such as generating one or more QR codes based on the information contained in the log. The QR codes may be recorded onto a QR printout form at block 1438. At block 1440 the application may determine whether there are any remaining ULDs. If it is determined that there are remaining ULDs the application may return to block 1436. If it is determined that no ULDs remain, block 1442 may involve converting the QR code form to a suitable document, such as a pdf document, and displaying the converted document to the user.

Block 1450 may involve viewing one or more resource codes. At block 1452 the application may load a pre-configured resource code sheet. In some examples, the pre-configured resource code sheet may be customized based on industry and/or customer preferences/requirements. At block 1454 the application may display the code sheet in a separate window. The window may stay open until the application closes (e.g., terminates) and/or the user closes the window

FIG. 15 illustrates an edit menus flow diagram 1500 according to exemplary embodiments of the present disclosure. The edit menus flow diagram 1500 may begin at an edit menu at block 1502. If the user desires to remove a ULD, block 1504 may determine whether a ULD is selected from the log. If no ULD has been selected block 1510 may indicate that the option to remove the ULD is not available. If it is determined that a ULD has been selected, at block 1506 the application may remove the selected ULD.

Block 1508 may involve re-organizing a data array and on-screen display of information. In some examples, block 1508 may be performed based on the removal of the selected ULD from block 1506. In some examples, the user may desire to add a flight, remove a flight, and/or view a flight. In such examples, block 1520 may involve launching an add flight process, a remove flight process, and/or a view flight process. At block 1522 the application may run the user selected option to display an on-screen list of flights contained in the database, add a flight to the database, and/or remove a flight from the database. In some examples, it may be desirable to change a flight number. In such examples, block 1530 may involve receiving information pertaining to a new flight number.

At block 1532 the application may validate that the flight is available in the database and/or if required prompt the user to add the flight number. In some examples, it may be desirable to change a load planner, change a scale operator, and/or change a plane side agent. In such examples, block 1540 may involve receiving a name of a new load planner, block 1550 may involve receiving a name of a new scale operator, and block 1560 may involve receiving a name of a new plane side agent.

After one or more of blocks 1540, 1550, and/or 1560 have been performed, block 1580 may determine whether all ULDs or future ULDs are contained on the log. If it is determined that all ULDs are contained on the log, block 1582 may involve updating all ULDs in the log with new information, such as information entered during the performance of any of blocks 1540, 1550, and/or 1560. At block 1584 the application may determine whether changes, such as updating the ULDs in the log with the new information, affect information in the printed placard. If block 1580 determines only future ULDs are on the log, or if block 1584 is satisfied, at block 1586 the application may record any new data with a time stamp. In some examples, block 1586 may apply to all items that are subsequently weighed. In some examples, it may be desirable to validate log data. In such examples, at block 1570 the application may trigger a validate log process. Block 1590 may involve ending operations.

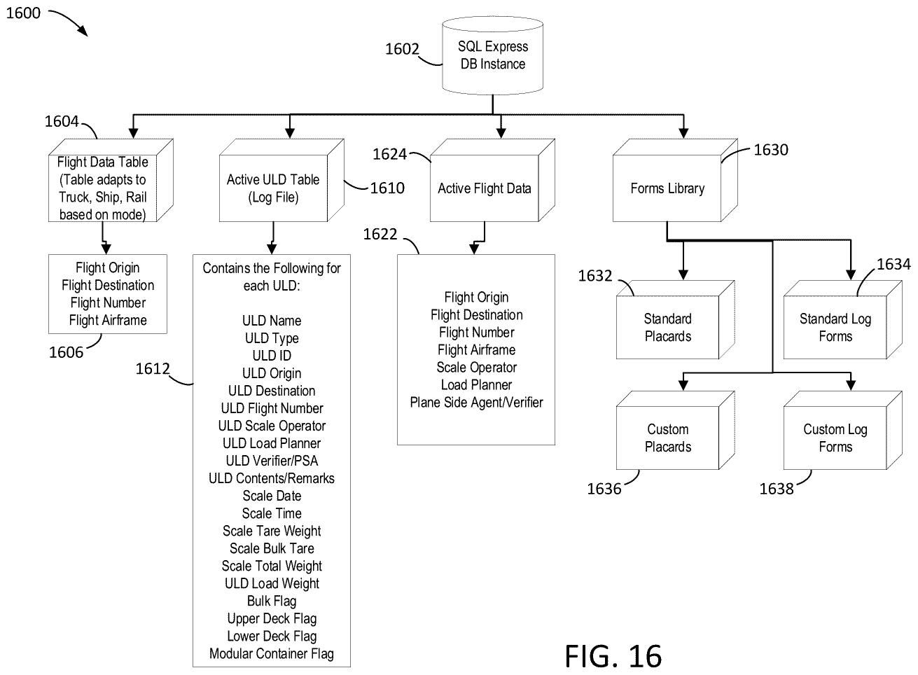

FIG. 16 illustrates a database schema 1600 according to exemplary embodiments of the present disclosure. Block 1602 may involve an SQL express database instance, but other types of databases may be used. The SQL express database instance may include one or more components, such as one or more components represented by blocks 1604, 1610, 1624, and 1630. Block 1604 may include a flight data table. In some examples the flight data table may be adapted for another industry based on a selected mode. For example, based on the selected mode the flight data table may be adapted for a truck, a ship, and/or a rail. Thus, in some examples the flight data table may be a data table for a specific industry.

Block 1606 may involve one or more components to be displayed on the data table in block 1604. For example, block 1606 may include information for display such as a flight origin, a flight, destination, a flight number, and/or a flight airframe. The information from block 1606 may be displayed on the data table for population by the user. For example, on the displayed data table the user may be prompted to enter the flight origin in the box labeled flight origin, enter the flight destination in the box labeled flight destination, enter the flight number in the box labeled flight number, and enter the flight airframe in the box labeled flight airframe.

Block 1610 may include one or more active ULD tables (e.g., a log file). Block 1612 may include information to be stored in each of the one or more active ULD tables. For example, block 1612 may include information such as a ULD name, a ULD type, a ULD ID, a ULD origin, a ULD destination, a ULD flight number, a ULD scale operator, a ULD load planner, a ULD verifier/PSA, a ULD contents/remarks section, a scale date, a scale time, a scale tare weight, a scale bulk tare, a scale total weight, a ULD load weight, a bulk flag, an upper deck flag, a lower deck flag, a modular container flag. In some examples one or more of the items at block 1612 may appear on the active ULD tables as a section to be populated by the user and/or appear as a selectable box that the user may toggle.

Block 1624 may include active flight data. Block 1622 may include at least a portion of the active flight data utilized at block 1624. For example, block 1622 may include active flight data such as flight origin data, flight destination data, flight number data, flight airframe data, scale operator data, load planner data, and/or verifier or plane side agent (PSA) data. In some examples, the active flight data may be input by the user and stored within the SQL express database. However, in other examples the active flight data may be received from another source.

Block 1630 may include a forms library. The forms library may include one or more forms. Block 1632 may include standard placards. Block 1634 may include standard log forms. Block 1636 may include custom placards. Block 1638 may include custom log forms. The custom placards and/or custom log forms may be customized based on industry and/or customer preferences/requirements. In some examples, the one or more forms may be editable and/or displayed to the user for population. For example, the user may utilize one or more of the forms when performing weighing operations described herein. In some examples, one or more of the forms may be populated based at least partially on data entered by the user during weighing operations.

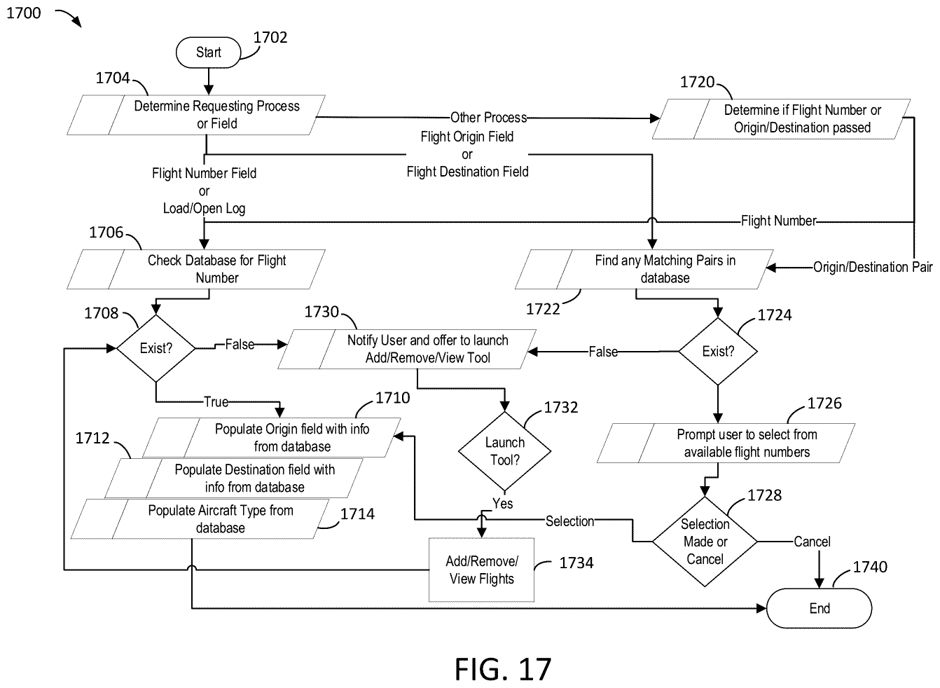

FIG. 17 illustrates a flight data lookup flow diagram 1700 according to exemplary embodiments of the present disclosure. The flight data lookup flow diagram 1700 may begin at block 1702. At block 1704 the application may determine a requesting process or field. A flight number field or a load/open log process may proceed to block 1706, a flight origin field or flight destination field may proceed to block 1722, and other processes may proceed to block 1720. At block 1706 the application may check the database for one or more flight numbers. Block 1708 may determine whether the one or more flight numbers exist in the database. If it is determined that the one or more flight numbers exist in the database, block 1710 may involve populating an origin field with information from the database. Block 1712 may involve populating a destination field with information from the database.

Block 1714 may involve populating an aircraft type with information from the database. If it is determined that the one or more flight numbers do not exist in the database, block 1730 may involve notifying the user of the determination from block 1708 and/or offering to launch the add/remove/view tool, such as through a pop-up indication or dialogue box. At block 1732 the application may determine whether the add/remove/view tool has been launched. If it is determined that add/remove/view tool has been launched, block 1734 may involve adding, removing, and/or viewing one or more flights.

In some examples, block 1704 may proceed to block 1722 based on a request for a flight origin field and/or a flight destination field. At block 1722 the application may search within the database for any matching pairs. At block 1722 the application may determine whether any matching pairs are contained within the database. If block 1724 is not satisfied, block 1730 may involve notifying the user that no matching pairs exist in the database and/or offering to launch the add/remove/view tool. If block 1724 is satisfied, such as one or more matching pairs are found to exist in the database, at block 1726 the application may prompt the user to select from one or more available flight numbers. Block 1728 may involve determining whether a selection at block 1726 was made and/or whether the user selected to cancel the prompt. If no selection was made or if cancel was selected, operations may end at block 1740. If a selection from available flight numbers was made the application may proceed to block 1710.

In some examples, block 1704 may proceed to block 1720. At block 1720 the application may determine if a flight number and/or an origin/destination is passed. If a flight number is passed, the application may proceed to previously described block 1706. If an origin/destination pair is passed, the application may proceed to previously described block 1722.

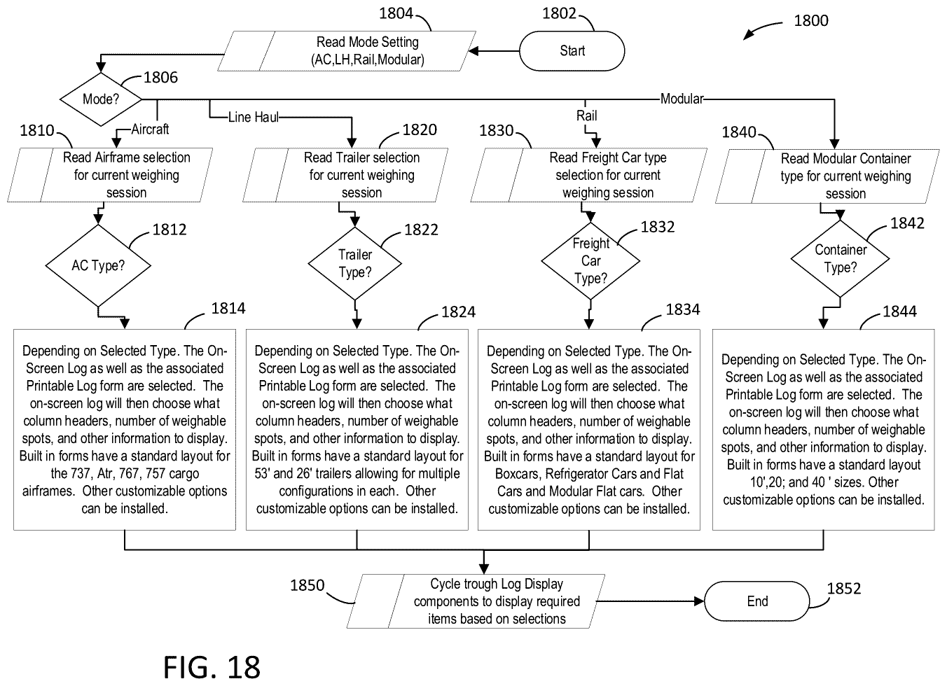

FIG. 18 illustrates a log display flow diagram 1800 according to exemplary embodiments of the present disclosure. The log display flow diagram 1800 may begin at block 1802 and proceed to block 1804. At block 1804 the application may read a mode setting; such as aircraft (AC), line haul (LH), rail, and modular. At block 1806 the application may determine what mode setting has been read. For example, for aircraft the application may perform blocks 1810-1814, for line haul the application may perform blocks 1820-1824, for rail the application may perform blocks 1830-1834, and for modular the application may perform blocks 1840-1844. After performing one or more of blocks 1804-1844, at block 1850 the application may cycle through the log display components to display the required items based on the user's selections before ending operations at block 1852.

Block 1810 may involve reading an airframe selection for the current weighing session. At block 1812 the application may determine a selected aircraft type. Based on the selected aircraft type, at block 1814 the on-screen log and/or the associated printable log form may be selected. Block 1814 may also involve the on-screen log choosing what column headers, number of weighable spots, and other desired information to display. For example, one or more built in (e.g., pre-programmed) forms may include a standard layout for a respective cargo airframe. However, in other examples customized forms may be installed. The customized forms may be based on an industry and/or consumer preference.

Block 1820 may involve reading a trailer selection for the current weighing session. At block 1822 the application may determine a selected trailer type. Based on the selected trailer type, at block 1824 the on-screen log and/or the associated printable log form may be selected. Block 1824 may also involve the application choosing what column headers, number of weighable spots, and other desired information to display. For example, one or more built in (e.g., pre-programmed) forms may include a standard layout for a respective trailer type, such as a 53 foot trailer and a 26 foot trailer each having one or more configurations. However, in other examples customized forms may be installed. The customized forms may be based on an industry and/or consumer preference.

Block 1830 may involve reading a freight car type selection for the current weighing session. At block 1832 the application may determine a selected freight car type. Based on the selected freight car type, at block 1834 the on-screen log and/or the associated printable log form may be selected. Block 1834 may also involve the on-screen log choosing what column headers, number of weighable spots, and other desired information to display. For example, one or more built in (e.g., pre-programmed) forms may include a standard layout for a respective freight car type, such as a boxcar, refrigerator car, flat car, and/or modular flat car. However, in other examples customized forms may be installed. The customized forms may be based on an industry and/or consumer preference.

Block 1840 may involve reading a modular container type selection for the current weighing session. At block 1842 the application may determine a selected modular container type. Based on the selected modular container type, at block 1844 the on-screen log and/or the associated printable log form may be selected. Block 1844 may also involve the on-screen log choosing what column headers, number of weighable spots, and other desired information to display. For example, one or more built in (e.g., pre-programmed) forms may include a standard layout for a respective modular container type, such as a 10 foot modular container, a 20 foot modular container, and/or a 40 foot modular container. However, in other examples customized forms may be installed. The customized forms may be based on an industry and/or consumer preference.

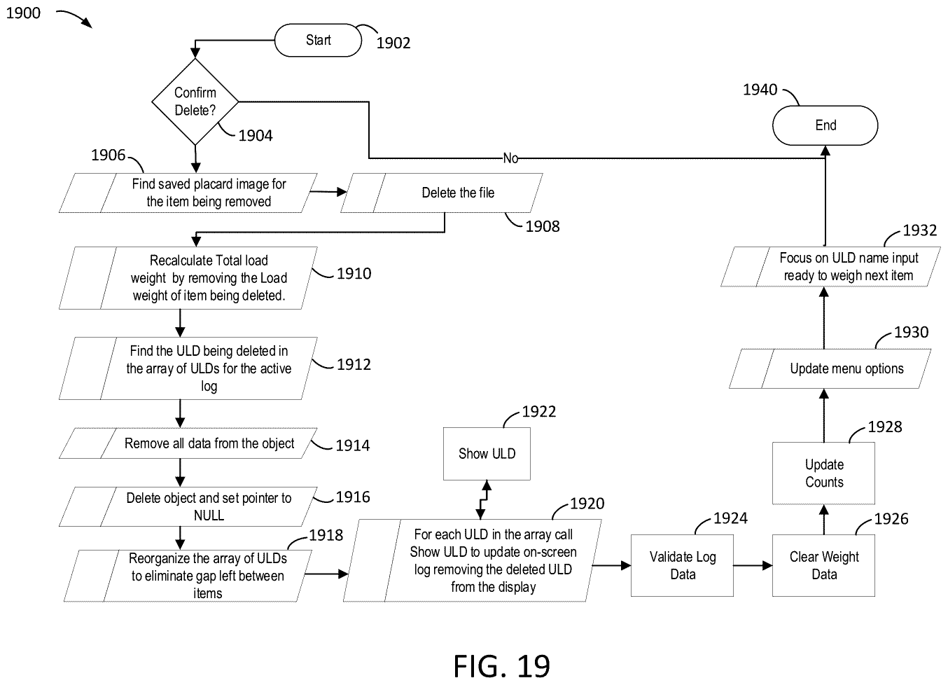

FIG. 19 illustrates a ULD removal flow diagram 1900 according to exemplary embodiments of the present disclosure. The ULD removal flow diagram 1900 may be used to remove and/or delete an existing ULD from the log file, for example. The ULD removal flow diagram 1900 may begin at block 1902. At block 1904 the application may determine whether a confirmation to delete has been selected. For example, the user may be required to select (e.g., clicking, selecting, hovering over, or actuating) a delete button on the display screen. If it is determined that the confirmation to delete has been selected, block 1906 may involve finding saved placard images for the item being removed. At block 1908 the application may delete one or more files, such as delete the saved placard images for the item.

At block 1910 the application may involve recalculating total load weight by removing the load weight of the item being deleted. Block 1912 may involve finding the ULD being deleted in the array of ULDs for the active log. At block 1914 the application may involve removing all data from the object. At block 1916 the application may delete the object and/or set a pointer to null. Block 1918 may involve reorganizing the array of ULDs to eliminate a potential gap left between items, such as a gap left from the ULD removed between items. At block 1920 the application may involve showing, for each ULD in the array call, the ULD to update the on-screen log removing the deleted ULD from the on-screen display. In some examples, block 1922 may show the ULD. At block 1924 the application may validate log data. Block 1926 may involve clearing weight data and block 1928 may involve updating counts, such counts for one or more items. At block 1930 the application may update menu items. Block 1932 may involve focusing on a ULD name input ready to weigh a subsequent item. Block 1940 may end operations.

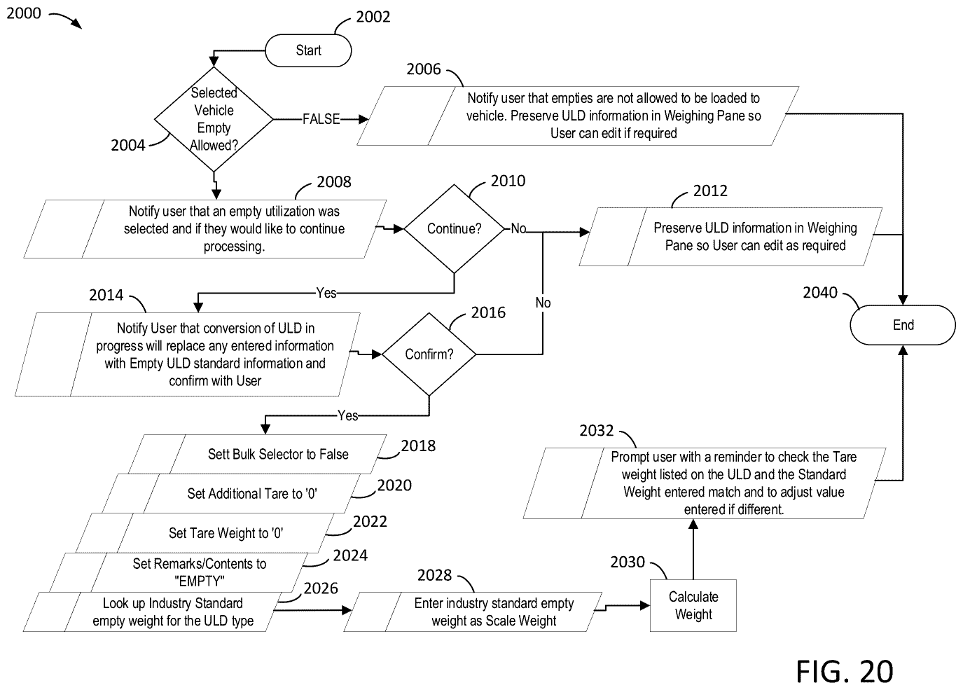

FIG. 20 illustrates an empty ULD flow diagram 2000 according to exemplary embodiments of the present disclosure. The empty ULD flow diagram 2000 may begin at block 2002. In some examples, a vehicle may not allow for transportation of an empty ULD. Thus, block 2004 may involve determining whether the selected vehicle allows for empty ULDs to be transported. If it is determined that empty ULDs are not allowed, block 2006 may involve notifying the user that empty ULDs are not allowed to be loaded onto the vehicle. In some examples, the ULD information in the weighing pane may be preserved to allow the user to edit the ULD information if desired. If it is determined that empty ULDs are allowed, block 2008 may involve notifying the user that an empty utilization was selected and prompted the user as to whether the user would like to continue processing.

At block 2010 the application may determine whether the user would like to continue processing. If it is determined that that user would not like to continue processing (e.g., by way of user input), block 2012 may involve preserving the ULD information in the weighing pane to allow the user to edit the ULD information if desired. If it is determined that the user would like to continue processing, block 2014 may involve notifying the user that conversion of the ULD in progress may replace any entered information with empty ULD standard information. In some examples, block 2014 may prompt the user to confirm continuing with the action. At block 2016 the application may determine whether the user has confirmed continuing with the action. If the user does not confirm the application may proceed to block 2012.

If the user confirms continuing with the action, one or more of blocks 2018-2026 may be performed. Block 2018 may involve setting a bulk selector to false. Block 2020 may involve setting an additional tare to zero (0). Block 2022 may involve setting a tare weight to zero (0). Block 2024 may involve setting remarks/contents to “EMPTY”. Block 2026 may involve looking up an industry standard empty weight for the ULD type. At block 2028 the application may enter the industry standard empty weight as a scale weight. At block 2030 the application may calculate a weight, such as a weight of the ULD. At block 2032 the application may prompt the user with a reminder to verify that a tare weight listed on the ULD and the standard weight entered match and/or to adjust a value if the weights are different. The operations may end at block 2040.

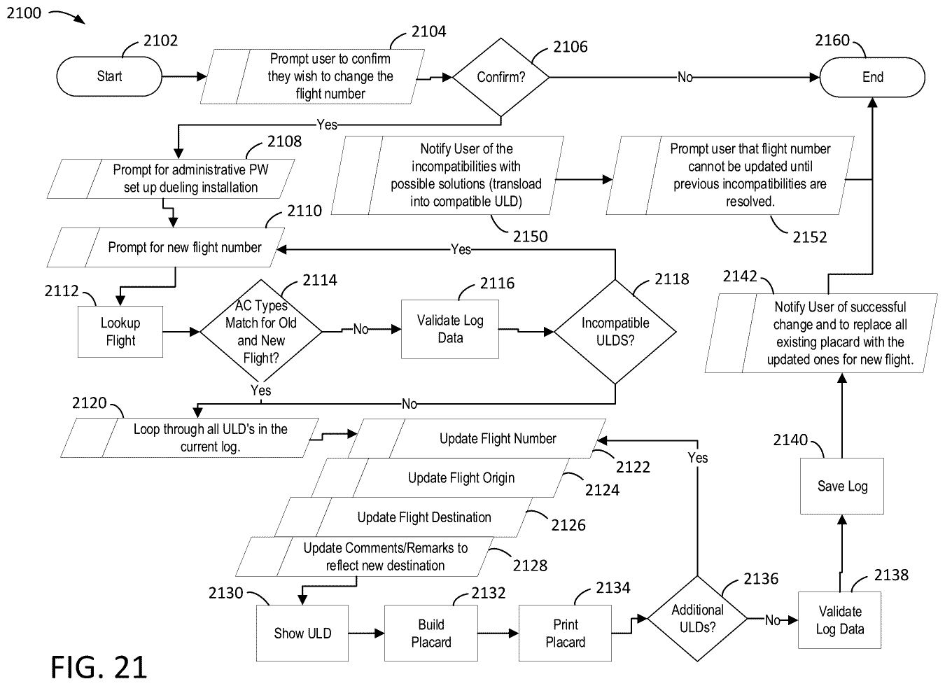

FIG. 21 illustrates a flight change flow diagram 2100 according to exemplary embodiments of the present disclosure. The flight change flow diagram 2100 may begin at block 2102. Block 2104 may involve prompting the user to confirm that the user intends to change the flight number. At block 2106 the application may determine whether the user confirms that a change to the flight number is intended. If it is confirmed that the user intends to change the flight number, block 2108 may involve prompting for an administrative password. In some examples, the administrative password may be set up during the installation process.

Block 2110 may involve prompting the user for a new flight number. At block 2112 the application may look up a flight. Block 2114 may involve determining whether vehicle types, such as an aircraft type, for an old and a new flight match. If it is determined that old and new vehicle types do not match, block 2116 may involve validating log data. At block 2118 the application may determine whether one or more present ULDs are compatible/incompatible. If it is determined that one or more present ULDs are incompatible the application may proceed to block 2110. If it is determined that one or more present ULDs are compatible the application may proceed to block 2120.

In examples where block 2114 determines that vehicle types for old and new flights match, block 2120 may involve looping through all ULDs in the current log. Block 2122 may involve updating the flight number with a new flight number. Block 2124 may involve updating the flight origin with a new flight origin. Block 2126 may involve updating the flight destination with a new flight destination. At block 2128 the application may update one or more comments/remarks to reflect the new destination. Blocks 2130, 2132, and 2134 may each respectively involve showing the ULD, building the placard, and printing the placard. At block 2136 the application may determine whether additional ULDs are present. If additional ULDs are present the application may return to block 2122. If no additional ULDs are determined at block 2136 the application may proceed to block 2138. At block 2138 the application may validate log data. Block 2140 may involve saving the log data. At block 2142 the application may notify the user of a successful change and to replace all existing placards with the updated placard reflecting the new flight details.

In some examples, block 2150 may notify the user of one or more incompatibilities and/or propose one or more possible solutions to the identified incompatibilities, such as transloading into a compatible ULD. At block 2152 the application may prompt the user that the flight number cannot be updated until previously identified incompatibilities from block 2150 have been resolved. Block 2160 may end one or more operations.

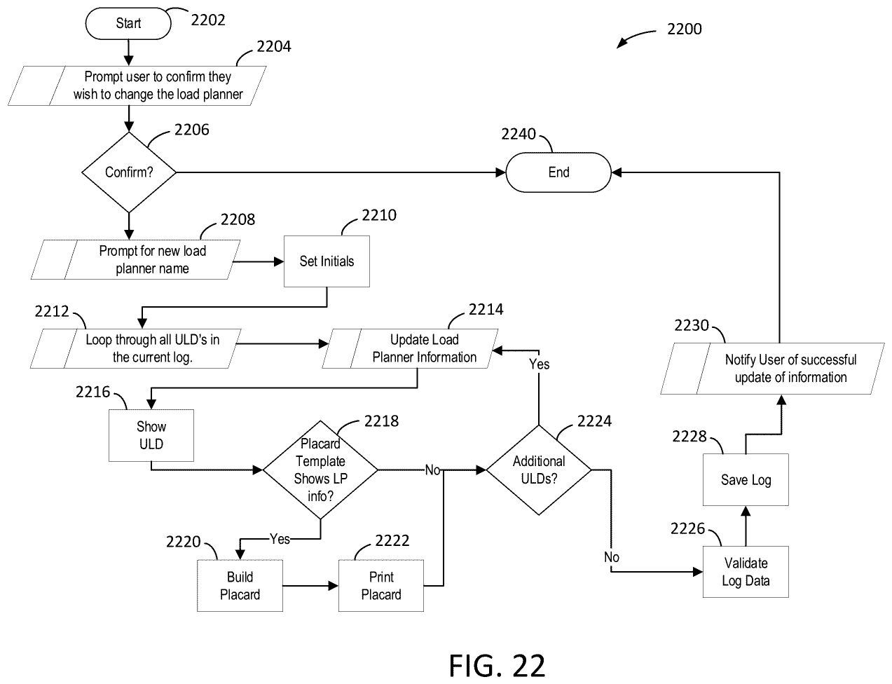

FIG. 22 illustrates a load planner modification flow diagram 2200 according to exemplary embodiments of the present disclosure. The load planner modification flow diagram 2200 may begin at block 2202. At block 2204 the application may prompt the user to confirm that the user intends to change the load planner. Block 2206 may determine whether the user intends to change the load planner. If the user does not intend to change the load planner the operations may end at block 2240. If it is determined that the user intends to change the load planner, block 2208 may involve prompting the user for a new load planner name. At block 2210 the application may set initials based on the new load planner name prompted at block 2208. At block 2212 the application may loop through all ULDs contained in the current log.

Block 2214 may involve updating the load planner information. At block 2216 the application may show one or more ULDs. Block 2218 may involve determining whether the placard template displays the load planner information. If it is determined that the placard template displays the load planner information, blocks 2220 and 2222 may respectively involve building a placard and printing the placard. If it is determined that the placard template does not display the load planner information the application may proceed to block 2224. Block 2224 may involve determining whether there are additional ULDs. If additional ULDs are determined to be present, the application may return to block 2214. If no additional ULDs are determined to be present, block 2226 may involve validating the log data. At block 2228 the application may save the log data validated at block 2226. At block 2230 the application may notify the user of a successful update of information before ending operations at 2240.

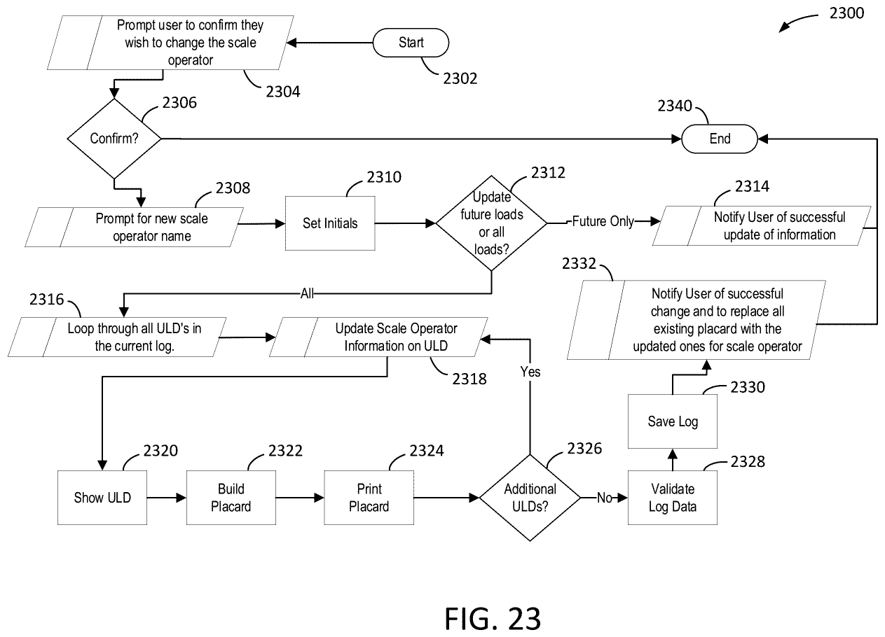

FIG. 23 illustrates a scale operator modification flow diagram 2300 according to exemplary embodiments of the present disclosure. The scale operator modification flow diagram 2300 may begin at 2302. At block 2304 the application may prompt the user to confirm that the user intends to change the scale operator. If the user does not intend to change the scale operator then block 2340 may end flow operations. If it is determined that the user has confirmed the intention to change the scale operator the application may proceed to block 2308. Block 2308 may involve prompting the user for a new scale operator name. Based on the new scale operator name from block 2308, block 2310 may set initials for the new scale operator name.

At block 2312 the application may determine whether to update all loads or future loads. If it is determined to only update future loads, block 2314 may involve notifying the user of successful update information. If it is determined to update all loads, at block 2316 the application may loop through all ULDs in the current log. At block 2318 the application may update the scale operator information on one or more ULDs. Blocks 2320, 2322, and 2324 may each respectively involve showing one or more ULDs, building a placard, and printing the built placard. At block 2326 the application may determine whether additional ULDs are present. If it is determined that additional ULDs are present the application may return to block 2318. If it determined that no additional ULDs are present the application may proceed to block 2328. Block 2328 may involve validating log data. Block 2330 may involve saving the validated log data. At block 2332 the application may notify the user of a successful change and to replace all existing placards with the updated placards for the scale operator. Flow operations may end at block 2340.

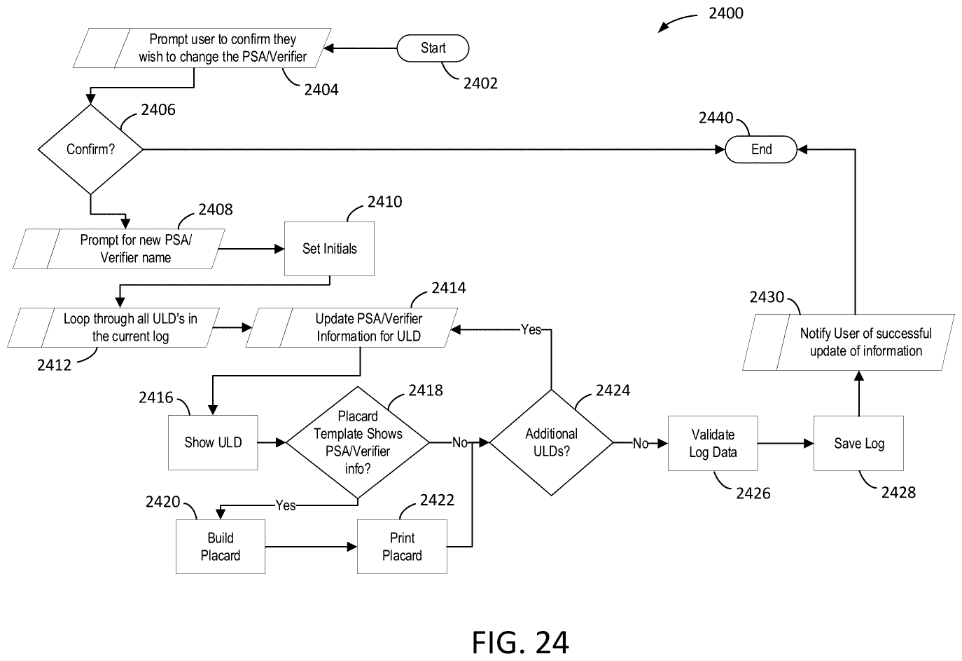

FIG. 24 illustrates a plane side agent (PSA) and verifier modification flow diagram 2400 according to exemplary embodiments of the present disclosure. The PSA and verifier modification flow diagram 2400 may begin at block 2402. At block 2404 the application may prompt the user to confirm that the user intends to change the PSA and/or verifier. At block 2406 the application may determine whether the user has confirmed that the user intends to change the PSA and/or verifier. If it is determined that the user has confirmed the intended change to the PSA and/or verifier, block 2408 may involve prompting the user for a new PSA and/or verifier name. Based on the new PSA and/or verifier name, block 2410 may involve setting initials for the new PSA and/or verifier. At block 2412 the application may loop through all ULDs in the current log.

Block 2414 may involve updating the PSA and/or verifier information for one or more ULDs. At block 2416 the application may show one or more ULDs. At block 2418 the application may determine whether a placard template displays the new PSA and/or verifier information. If it is determined that the new PSA and/or verifier information is displayed on the placard, block 2420 may involve building the placard and block 2422 may involve printing the built placard. If it is determined that the new PSA and/or verifier is not displayed on the placard the application may proceed to block 2424. At block 2424 the application may determine whether any additional ULDs are present. If it is determined that additional ULDs are present the application may return to block 2414. If no additional ULDs are present, block 2426 may validate the log data and block 2428 may save the validated log data. At block 2430 the application may notify the user of a successful update of information before ending operations at block 2440.

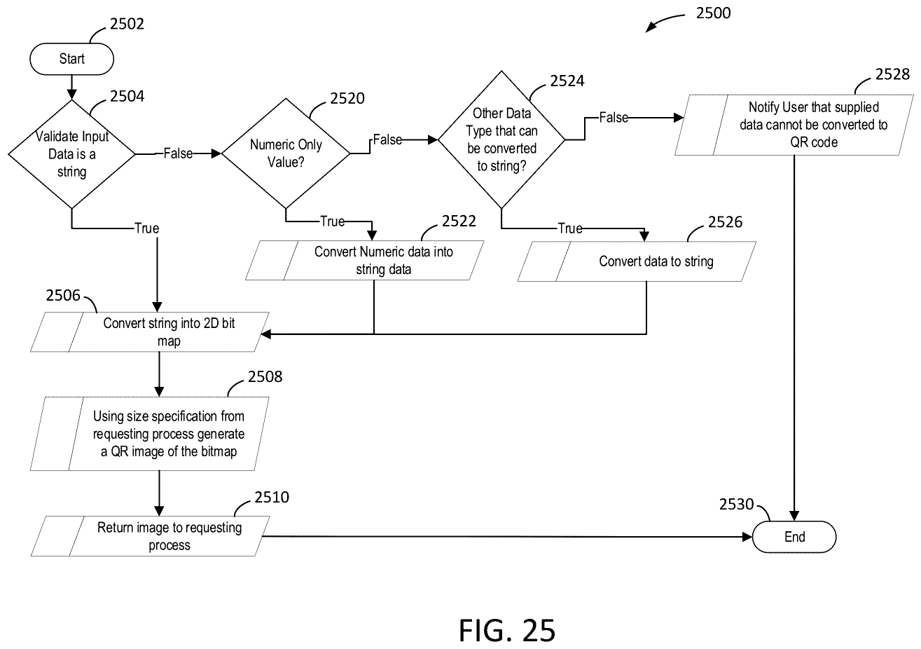

FIG. 25 illustrates a QR code generation flow diagram 2500 according to exemplary embodiments of the present disclosure. The QR code generation flow diagram 2500 may begin at block 2502. At block 2504 the application may validate that the input data is a string. If the input data is validated as a string the application may proceed to block 2506. At block 2506 the application may convert the string into a two-dimensional bit map. Block 2508 may involve using a size specification from a requesting process to generate a QR image of the bitmap. Block 2510 may involve returning an image to the requesting process. In some examples, a default format for the image at block 2510 is a JPG or PNG file, however in other examples another format may be specified by the requesting process. If the input data is not validated as a string the application may proceed to block 2520.

At block 2520 the application may determine whether a numeric only value is present. If it is determined that a numeric only value is present, block 2522 may involve converting the numeric data into a data string. Once converted to the data string, the application may proceed to block 2506. If it is determined that a numeric only value is not present, at block 2524 the application may determine whether other data types are present that may be converted to a string. If other data types are present that may be converted to a string the application may convert the data to the string at block 2526. If no other data types are present that may be converted to the string, block 2528 may include notifying the user that the supplied data cannot be converted to a QR code. Flow diagram operations may end at block 2530.

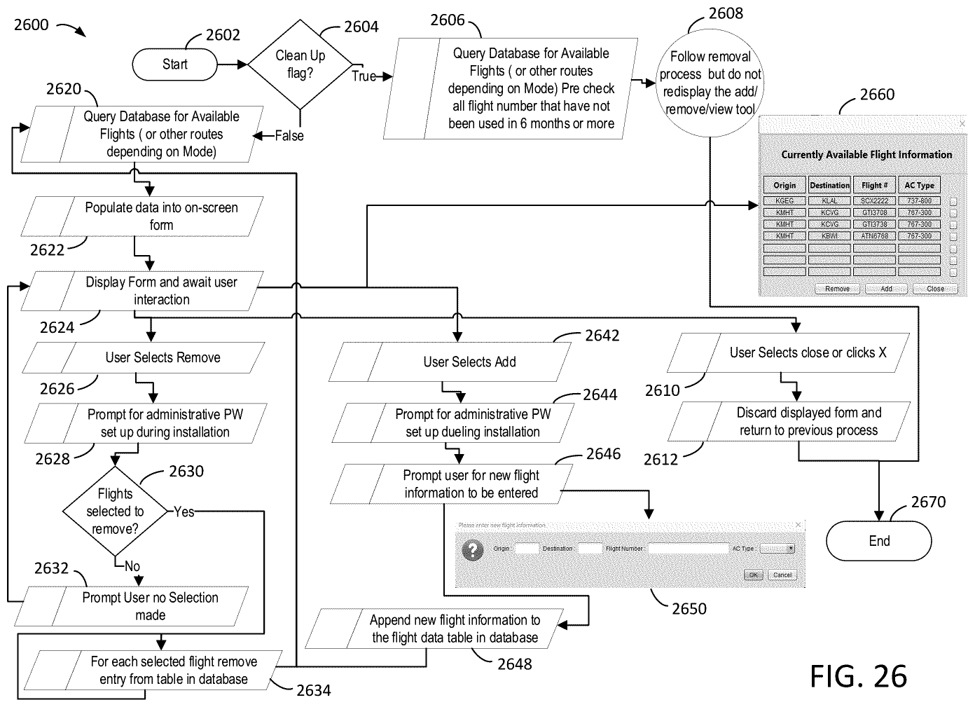

FIG. 26 illustrates a flight addition, removal, and verification flow diagram 2600 according to exemplary embodiments of the present disclosure. The flight addition, removal, and verification flow diagram 2600 may begin at block 2602. At block 2604 the application may determine whether the clean up flag is set. The clean up flag may be used to remove outdated and/or obsolete information from the database to reduce an occurrence of incorrect information being utilized and/or increase available storage space. If block 2604 is satisfied the application may proceed to block 2606. At block 2606 the application may query the database for available flights and/or other routes depending on the vehicle type selected (e.g., the mode). In some examples, block 2606 may also pre-check all flight numbers that have not been used in a given period of time, such as all flight numbers that have not been used in six months or longer. Block 2608 may involve following a removal process. In some examples, block 2608 may not redisplay the add/remove/view tool. Block 2610 may involve the user selecting a close feature, such as clicking, selecting, hovering over, or actuating an “X” selector on a box to close the box. At step 2612 the application may discard a displayed form and/or return to a previous process before ending operations at block 2670.

If block 2604 is not satisfied, block 2620 may involve querying the database for available flights and/or one or more other routes depending on the vehicle selected (e.g., the mode). Block 2622 may involve populating data into an on-screen form. At block 2624 the application may display the form and in some examples await user interaction. An example form may be seen at block 2660, which may include currently available flight information including origin, destination, flight number, and/or aircraft type. Block 2626 may involve the user selecting to remove an item. At block 2628 the application may prompt the user for an administrative password that has been set up during the installation process described herein.

Block 2630 may involve determining whether any flights have been selected for removal. If it is determined that one or more flights have been selected for removal, at block 2634 the application may remove entries from the table in the database for each selected flight to remove. If it is determined that one or more flights have not been selected for removal, at block 2632 the application may prompt the user that no selection has been made.

Block 2642 may involve the user selecting to add a new flight. At block 2644 the application may prompt the user for an administrative password that has been set up during the installation process. Block 2646 may involve prompting the user for new flight information to be entered. An example prompt of the new flight information to be entered may be seen at block 2650. The example prompt at block 2650 may include an origin of the new flight, a destination of the new flight, a flight number of the new flight, and/or an aircraft type of the new flight. At block 2648 the application may append the new flight information to the flight data table in the database. In some examples, after completing block 2648 the application may return to block 2620.

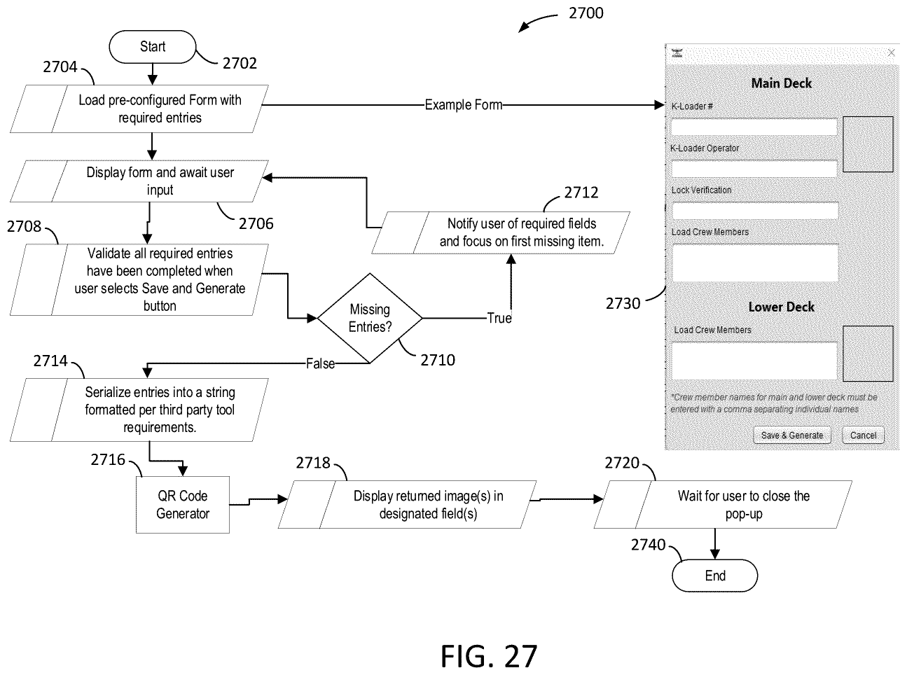

FIG. 27 illustrates an ALV menu flow diagram 2700 according to exemplary embodiments of the present disclosure. The ALV may be used to verify information input during one or more operations described herein. The ALV menu flow diagram 2700 may begin at block 2702. At block 2704 the application may load a pre-configured form with one or more entries, such as required entries. Block 2730 illustrates an example form that may be loaded as a result of performing block 2704. However, in other examples another pre-configured form may be used. For example the pre-configured form may be customized to desired customer, industry, and/or third party preferences or requirements. Block 2706 may involve displaying the form and awaiting user input into the displayed form. The form may be displayed on the display screen of the user device, for example.

At block 2708 the application may validate that all required entries have been completed. In some examples, the validation at block 2708 may occur when the user performs an action, such as selecting a save button and/or a generate button. Block 2710 may involve determining whether any entries may be missing. If it is determined that an entry may be missing, block 2712 may involve notifying the user of one or more required fields and/or emphasizing on a first missing item from the one or more required fields. If it is determined that no entries are missing, block 2714 may involve serializing one or more entries into a string. In some examples, the string may be formatted based on a requirement and/or preference of a third party tool.

At block 2716 a QR code generator may be performed. The QR code generator may generate a QR code based on the one or more entries. In some examples, the QR code generator may utilize one or more process described in FIG. 25. Block 2718 may involve displaying one or more returned images in their respective designated fields. In some examples, block 2718 may occur in the form of a dialogue box or pop-up box. At block 2720 the application may wait for the user to close the pop-up and/or dialogue box prior to ending operations at block 2740.

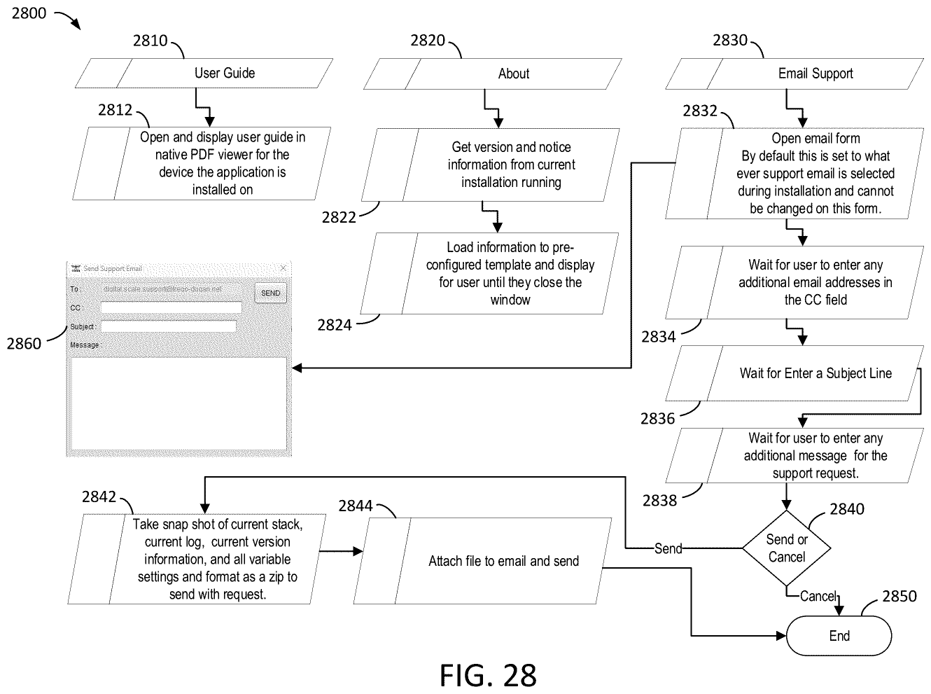

FIG. 28 illustrates a help menu flow diagram 2800 according to exemplary embodiments of the present disclosure. At block 2810 the help menu flow may include a user guide section. Block 2812 may involve opening and displaying the user guide in a native pdf viewer for the device that the application is installed on. However, in other examples another document format may be used and/or a device other than the device the application is installed on may be used. At block 2820 the help menu flow may include an about section. Block 2822 may involve receiving a version and notice information from a currently running installation. Block 2824 may involve loading information pertaining to the pre-configured template and/or displaying to the user, such as on the display screen, until the user closes the window (e.g., closes the pop-up). At block 2830 the help menu flow may include an email support section.

Block 2832 involves opening an email form. In some examples, the default setting for the email form is set to a support email selected during the installation process. In some such examples, the default setting for the email form may be amendable by the user, while in other such examples the default setting for the email form may not be amendable by the user. Block 2860 illustrates an example email form that may occur as a result of performing one or more operations at block 2832. At block 2834 that application may wait for the user to enter any additional email addresses in the CC field. Block 2836 may involve waiting for the user to enter a subject line. Block 2836 may involve waiting for the user to enter a message in a message box for the support request.

At block 2840 the application may determine whether a send or cancel selection has been made, for example determining whether the user has selected to send the support request email or cancel the support request email. If it is determined that the user has selected to send the support request email, block 2842 may involve capturing an image of one or more of a current stack, a current log, a current version of the information, and/or one or more variable settings. The captured image(s) may be formatted as a zip file and may be included along with the support request email upon sending. At block 2844 the application may attach one or more files to the support request email, such as files generated at block 2842, and send the email to a recipient. Flow diagram operations may end at block 2850.

FIG. 29 illustrates an on screen display of a full screen interface 2900 according to exemplary embodiments of the present disclosure. In some examples the full screen interface 2900 includes one or more interactive features that may allow the user to input (e.g., via a scanner device configured to read a bar code and/or manually) desired information and/or actuate to perform an action. For example, full screen interface 2900 may allow the user to input information pertaining to the vehicle type, the flight number, the flight origin, the flight destination, the load planner, the primary scale operator, and/or the secondary scale operator. In some examples, the user may actuate an interactive feature to begin scale operations. The full screen interface 2900 may also display relevant ULD information for a current ULD undergoing scale operations, and/or display a current scale log of each weighed ULD corresponding to the flight number. Thus, the full screen interface 2900 may include one or more components from the previously described figures, such as including one or more components from FIGS. 5A, 6A, and 10A.

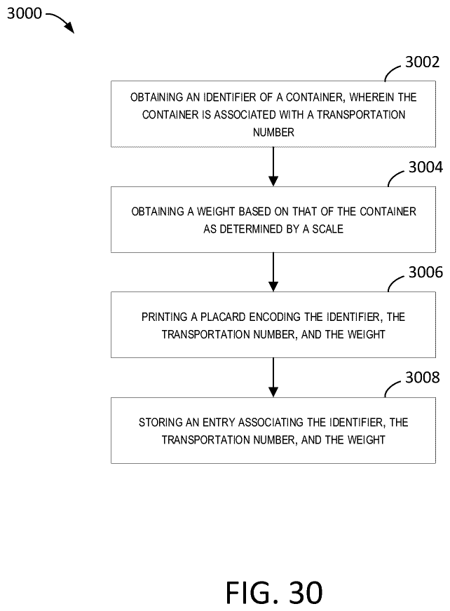

FIG. 30 is a flow chart illustrating an example embodiment. The process 3000 illustrated by FIG. 30 may be carried out by a computing device, such as computing device 100, and/or a cluster of computing devices, such as server cluster 200. However, the process 3000 can be carried out by other types of devices or device subsystems. For example, the process 3000 could be carried out by a portable computer, such as a laptop or a tablet device.

The embodiments of FIG. 30 may be simplified by the removal of any one or more of the features shown therein. Further, these embodiments may be combined with features, aspects, and/or implementations of any of the previous figures or otherwise described herein.

At block 3002 the process 3000 may include obtaining an identifier of a container, wherein the container is associated with a transportation number. In some examples, the identifier may be obtained by way of a scanning device coupled to a computing system.

At block 3004 the process 3000 may also include obtaining a weight based on that of the container as determined by a scale. In some examples, the weight may be obtained by way of the scanning device.

At block 3006 the process 3000 may also include printing a placard encoding the identifier, the transportation number, and the weight. In some examples, the placard may be printed by a printing device coupled to the computing system.

At block 3008 the process 3000 may also include storing an entry associating the identifier, the transportation number, and the weight. In some examples, the entry may be stored in a database associated with the computing system.

In some examples of the process 3000, the placard also encodes a location on a vehicle within which the container is to be loaded, and wherein the entry also associates the location with the identifier, the transportation number, and the weight.

In some examples of the process 3000, the transportation number comprises a flight number, a shipment number, a tracking number, or a route number.

In some examples of the process 3000, the container is loadable in an aircraft, a train car, or a trucking vehicle.

In some examples, the process 3000 may also include obtaining, by way of the scanning device, a further identifier of a dolly upon which the container is disposed when placed on the scale, where the further identifier is associated with a dolly tare weight.

In some such examples of the process 3000, the weight is also based on the dolly tare weight, where the dolly tare weight is subtracted from the weight when the container is loaded onto a vehicle without the dolly, and where the dolly tare weight is included in the weight when the container is loaded onto the vehicle with the dolly.

In some examples, the process 3000 may also include obtaining, by way of the scanning device or a user input, a utilization percentage of the container, where the entry also associates the utilization percentage with the identifier, the transportation number, and the weight.

In some examples, the process 3000 may also include obtaining, by way of the scanning device or a user input, content information of the container.

In some examples of the process 3000, the transportation number is obtained by scanning a scannable feature coupled to the container.

In some examples, the process 3000 may also include determining whether the weight of the container is within a predetermined weight range for a container type associated with the identifier of the container.

In some examples, the process 3000 may also include determining whether the weight of the container is within a predetermined weight range for a vehicle on which the container is to be loaded.

In some examples, the process 3000 may also include determining, based on a container type associated with the identifier of the container, whether the container is compatible with a vehicle on which the container is to be loaded.

In some examples, the process 3000 may also include receiving an input indicating that the container is empty; and determining, based on the input, whether the weight is within a predetermined range for an empty container of a type associated with the identifier of the container.

In some examples of the process 3000, the encoding on the placard is a quick response (QR) code, a barcode, or an alphanumeric code.

In some examples, the process 3000 may also include obtaining, by way of the scanning device, a second identifier of a second container, where the second container is associated with a second transportation number; obtaining, by way of the scanning device, a second weight based on that of the second container as determined by the scale; printing, by the printing device, a second placard for the second container encoding the second identifier, the second transportation number, and the second weight; and storing, in the database, a second entry for the second container associating the second identifier, the second transportation number, and the second weight.

In some such examples, the process 3000 may also include determining that the identifier and the second identifier are identical; and indicating, by the computing system, that the identifier and the second identifier are duplicative.

In some such examples, the process 3000 may also include generating, based on the entry and the second entry, a scale log sheet, where the scale log sheet includes the identifier, the second identifier, the transportation number, the second transportation number, the weight, and the second weight; and storing, in the database, the scale log sheet.

In some such examples of the process 3000 the second transportation number is the transportation number.

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting.

What is claimed is:

1. A computer-implemented method comprising:
obtaining, by way of a scanning device coupled to a computing system, an identifier of a container, wherein the container is associated with a transportation number;
obtaining, by way of the scanning device, a weight based on that of the container as determined by a scale;
printing, by a printing device coupled to the computing system, a placard encoding the identifier, the transportation number, and the weight; and
storing, in a database associated with the computing system, an entry associating the identifier, the transportation number, and the weight.

2. The computer-implemented method of claim 1, wherein the placard also encodes a location on a vehicle within which the container is to be loaded, and wherein the entry also associates the location with the identifier, the transportation number, and the weight.

3. The method of claim 1, wherein the transportation number comprises a flight number, a shipment number, a tracking number, or a route number.

4. The method of claim 1, wherein the container is loadable in an aircraft, a train car, or a trucking vehicle.

5. The method of claim 1, further comprising:
obtaining, by way of the scanning device, a further identifier of a dolly upon which the container is disposed when placed on the scale, wherein the further identifier is associated with a dolly tare weight.

6. The method of claim 5, wherein the weight is also based on the dolly tare weight, wherein the dolly tare weight is subtracted from the weight when the container is loaded onto a vehicle without the dolly, and wherein the dolly tare weight is included in the weight when the container is loaded onto the vehicle with the dolly.

7. The method of claim 1, further comprising:
obtaining, by way of the scanning device or a user input, a utilization percentage of the container, wherein the entry also associates the utilization percentage with the identifier, the transportation number, and the weight.

8. The method of claim 1, further comprising:
obtaining, by way of the scanning device or a user input, content information of the container.

9. The method of claim 1, wherein the transportation number is obtained by scanning a scannable feature coupled to the container.

10. The method of claim 1, further comprising:
determining whether the weight of the container is within a predetermined weight range for a container type associated with the identifier of the container.

11. The method of claim 1, further comprising:
determining whether the weight of the container is within a predetermined weight range for a vehicle on which the container is to be loaded.

12. The method of claim 1, further comprising:
determining, based on a container type associated with the identifier of the container, whether the container is compatible with a vehicle on which the container is to be loaded.

13. The method of claim 1, further comprising:
receiving an input indicating that the container is empty; and
determining, based on the input, whether the weight is within a predetermined range for an empty container of a type associated with the identifier of the container.

14. The method of claim 1, wherein the encoding on the placard is a quick response (QR) code, a barcode, or an alphanumeric code.

15. The method of claim 1, further comprising:
obtaining, by way of the scanning device, a second identifier of a second container, wherein the second container is associated with a second transportation number;
obtaining, by way of the scanning device, a second weight based on that of the second container as determined by the scale;
printing, by the printing device, a second placard for the second container encoding the second identifier, the second transportation number, and the second weight; and
storing, in the database, a second entry for the second container associating the second identifier, the second transportation number, and the second weight.

16. The method of claim 15, further comprising:
determining that the identifier and the second identifier are identical; and
indicating, by the computing system, that the identifier and the second identifier are duplicative.

17. The method of claim 15, further comprising:
generating, based on the entry and the second entry, a scale log sheet, wherein the scale log sheet comprises the identifier, the second identifier, the transportation number, the second transportation number, the weight, and the second weight; and
storing, in the database, the scale log sheet.

18. The method of claim 15, wherein the second transportation number is the transportation number.

19. A computing system comprising:
one or more processors; and
a non-transitory computer readable medium comprising program instructions executable by the one or more processors to perform operations comprising:
obtaining, by way of a scanning device, an identifier of a container, wherein the container is associated with a transportation number;
obtaining, by way of the scanning device, a weight based on that of the container as determined by a scale;
printing, by a printing device, a placard encoding the identifier, the transportation number, and the weight; and
storing, in a database, an entry associating the identifier, the transportation number, and the weight.

20. A non-transitory computer readable medium comprising program instructions executable by one or more processors to perform operations comprising:
obtaining, by way of a scanning device, an identifier of a container, wherein the container is associated with a transportation number;
obtaining, by way of the scanning device, a weight based on that of the container as determined by a scale;
printing, by a printing device, a placard encoding the identifier, the transportation number, and the weight; and
storing, in a database, an entry associating the identifier, the transportation number, and the weight.
